(19) United States
(12) Patent Application Publication
(10) Pub. No.: US 2025/0017255 A1
(43) Pub. Date: Jan. 16, 2025

(54) SHUTTER PIECE AND SHUTTER SET FOR MOLDING FOOD DOUGH

(71) Applicant: RHEON AUTOMATIC MACHINERY CO., LTD., Tochigi (JP)

(72) Inventor: Yasunori KONDO, Tochigi (JP)

(21) Appl. No.: 18/712,872

(22) PCT Filed: Nov. 29, 2022
(86) PCT No.: PCT/JP2022/043927

§ 371 Date: May 23, 2024

(30) Foreign Application Priority Data
Nov. 29, 2021 (JP) 2021-193127

(51) Int. Cl. A23P 20/20

(52) U.S. Cl. CPC A23P 20/20

(57) ABSTRACT

A shutter piece includes an upper portion and a lower portion of an opening-side surface. The upper portion has an upper edge and an intermediate edge, and is configured to close a front end of the intermediate edge after a front end of the upper edge is closed when the plurality of shutter pieces is swung to close the opening. The lower portion includes a protruding edge disposed between the upper edge and the intermediate edge in the plan view. The shutter piece is configured to define a ceiling space for receiving the peripheral portion of the outer skin material when the front end of the upper edge is closed. The shutter piece is configured to reduce the upper space while the outer skin material in the ceiling space is held by the lower portion until the front end of the intermediate edge is closed.

### TECHNICAL FIELD

The present invention relates to a shutter set used to envelop an inner material with a flat food dough, and a shutter piece constituting the shutter set.

### BACKGROUND ART

Patent document 1 is directed to an enveloping and forming method and apparatus for a food product, and discloses that a peripheral edge portion of an outer skin material is attached and sealed to itself to allow an inner material to be enveloped by a closing operation of a shutter set constituted by combining a plurality of shutter pieces. A side surface of each shutter piece has a front edge which closes earlier by a closing operation of the shutter set, a base edge which closes later than the front edge, and a slope surface between the front edge and the base edge.

In this forming method, the peripheral edge portion of the outer skin material is attached and sealed to itself by the base edge in a state that the front edges or the slope surfaces of the adjacent shutter pieces are closed, so that the outer skin material can envelop the inner material without protruding from the shutter set (Patent Document 1).

Patent Document 2 discloses a shutter piece, a shutter set, a shutter device and a forming apparatus used for forming an enveloped food product. The shutter piece has a first side surface for attaching and sealing the peripheral edge portion of the outer skin material to itself at a position above the inner skin material, and a second side surface which is located below the first side surface and contacts the outer skin material earlier than the first side surface to gather the outer skin material toward a position above a center of the inner skin material.

In the shutter piece configured in this way, the second side surface contacts the outer skin material earlier than the first side surface which is for attaching and sealing the outer skin material to itself. Since the second side surface is located lower than the first side surface, the outer skin material near the inner material is concentratively gathered and stretched, so that a gathering effect can be enhanced. Then, the outer skin material gathered above the inner material is attached and sealed to itself by the first side surface.

In this shutter set, the closing operation is stopped when the front edge of the first side surface of each shutter piece is at a center of an opening of the shutter set, to close the opening. At this time, a recessed space is formed at the center of the lower surface of the shutter set (Patent Document 2).

Further, at a bottom of the shutter piece described in Patent Documents 1 and 2, an intersection angle between the side surface defining the opening and a bottom surface of the shutter piece is about a right angle.

### PRIOR ART PUBLICATION

Patent Publication 1: Japanese Patent Laid-open Publication No. 2003-052299
Patent Publication 2: International Publication No. WO 2016/199720

### SUMMARY OF THE INVENTION

### Problem to be Solved by the Invention

In the shutter set described in the Patent Document 1, the outer skin material does not protrude from an upper surface of the shutter set during the closing operation. However, since the base edge is perpendicular to the upper and lower surfaces of the shutter piece, the outer skin material is easy to move downward, so that the sealing of the outer skin material may be insufficient.

In the shutter set described in Patent Document 2, when the opening of the shutter set is closed, the outer skin material may be protruded onto the upper surface of the shutter set. To avoid this, stopping the closing operation before the opening of the shutter set is closed may allow the outer skin material to be remained more than necessary at the top of the enveloped food product and protruded so that an appearance of the enveloped food product may be deteriorated. Further, the sealing of the outer skin material may be insufficient.

Further, when the opening of the shutter set is closed, the outer skin material may be stored in a recessed space at the lower surface of the shutter set. However, the physical properties of the outer skin material may cause the outer skin material to be insufficiently sealed.

Further, when the shutter set gathers the outer skin material toward the center, the bottom of the shutter piece may roughen the surface of the outer skin material.

The present invention is for solving the above-stated problem, and has a first object to provide a shutter piece, a shutter set, a shutter device and a forming apparatus which are capable of surely attaching and sealing an outer skin material to itself when an enveloped food is formed.

Further, the present invention has an object to provide a shutter piece, a shutter set, a shutter device, and a forming apparatus which are capable of preventing a surface of an outer skin material from being rough when an enveloped food is formed.

### Means for Solving the Problem

The present invention is directed to a shutter piece of a shutter set used in a shutter device for enveloping an inner material by a disk-like outer skin material, a center of which the inner material is supplied onto, to form a enveloped food product, the shutter piece including a first side surface for attaching and sealing a peripheral edge portion of the outer skin material to itself above the inner material, and a second side surface located below the first side surface for contacting the outer skin material before the first side surface to gather the outer skin material toward a position above a center of the inner material, wherein, in the plan view, the first side surface includes a convex upper edge extending from a base end to a front end, and a convex lower edge extending from a base end to a front end at a position recessed from the first side surface, and wherein in the plan view, the second side surface includes a convex protruding edge extending from a base end to a front end between the upper edge and the lower edge, and a horizontal portion.

For example, the shutter piece may further include an intermediate side surface between the first side surface and the second side surface, and the intermediate side surface may vertically have the same contour as the lower edge of the first side surface.

For example, the protruding edge may be formed as a peripheral edge of the horizontal portion.

For example, the protruding edge may be formed as a peripheral edge of an upper slope portion extending obliquely downward from the horizontal portion to protrude from the horizontal portion.

For example, the second side surface may include a vertical surface vertically having the same contour as the protruding edge.

For example, in the plan view, a width between the lower edge and the protruding edge of the first side surface may became smaller from the base end toward the front end of the second side surface.

For example, the second side surface may further include a lower slope portion extending obliquely downward from the protruding edge to be recessed from the protruding edge.

For example, the shutter piece may further include a front-end surface which is located below the first side surface and closer to the base end than the front edge of the first side surface and intersects a front portion of the second side surface.

For example, the shutter piece may further include a lower horizontal surface extending from the upper end of the front surface toward the front portion of the shutter piece.

For example, the shutter piece may form a portion of a ceiling space by at least the first side surface, the second side surface, and the front surface when the shutter unit is closed.

For example, the shutter piece may form a portion of a ceiling space by the second side surface, the front surface, and the lower horizontal surface when the shutter unit is in a fully-closed state.

For example, a shutter set may be formed by combining the shutter pieces.

For example, a shutter device may include the shutter set.

For example, a forming apparatus may include the shutter device.

### Effects of the Invention

The shutter piece, the shutter set, the shutter device, and the forming apparatus according to the present invention allows the outer skin material to be surely attached and sealed to itself. Further, the shutter piece, the shutter set, the shutter device, and the forming apparatus according to the present invention allows a surface of the outer skin material to be prevented from being roughened when the outer skin material is attached and sealed to itself.

### BRIEF DESCRIPTION OF THE DRAWINGS

FIG. 1 is a plan view of a shutter device including a shutter piece and a shutter set according to a first embodiment of the present invention in an opened state of an opening.

FIG. 2 is a plan view of a shutter piece according to a first embodiment of the present invention.

FIG. 3 is a bottom view of the shutter piece shown in FIG. 2.

FIG. 4 is a plan-side perspective view of combined shutter pieces each of which is shown in FIG. 2.

FIG. 5 is a bottom-side perspective view of combined shutter pieces each of which is shown in FIG. 2.

FIG. 6 is a bottom-side perspective view of a shutter set including a shutter piece according to the first embodiment of the present invention at a starting closing state.

FIG. 7 is a partially enlarged view of FIG. 6.

FIG. 8 is a bottom-side perspective view of a shutter set including a shutter piece according to the first embodiment of the present invention in a fully-closed state.

FIG. 9 is a partially enlarged view of FIG. 8.

FIG. 10A is a plan view showing an open-close motion of the shutter set.

FIG. 10B is a plan view showing an open-close motion of the shutter set.

FIG. 10C is a plan view showing an open-close motion of the shutter set.

FIG. 11A is a plan view showing an open-close motion of the shutter set at a cross section including the protruding edge.

FIG. 11B is a plan view showing an open-close motion of the shutter set at a cross section including the protruding edge.

FIG. 11C is a plan view showing an open-close motion of the shutter set at a cross section including the protruding edge.

FIG. 12 is a schematic view showing a motion of the forming apparatus including the shutter piece shown in FIG. 1.

FIG. 13 is a schematic view showing a motion of the forming apparatus including the shutter piece shown in FIG. 1.

FIG. 14 is a schematic view showing a motion of the forming apparatus including the shutter piece shown in FIG. 1.

FIG. 15 is a schematic view showing a motion of the forming apparatus including the shutter piece shown in FIG. 1.

FIG. 16 is a schematic view showing a motion of the forming apparatus including the shutter piece shown in FIG. 1.

FIG. 17 is a schematic view showing a motion of the forming apparatus including the shutter piece shown in FIG. 1.

FIG. 18 is a schematic view showing a motion of the forming apparatus including the shutter piece shown in FIG. 1.

FIG. 19 is a schematic view showing a motion of the forming apparatus including the shutter piece shown in FIG. 1.

FIG. 20 is a schematic view showing a motion of the forming apparatus including the shutter piece shown in FIG. 1.

FIG. 21 is a schematic view showing a motion of the forming apparatus including the shutter piece shown in FIG. 1.

FIG. 22 is a schematic view showing a motion of the forming apparatus including the shutter piece shown in FIG. 1.

FIG. 23 is a plan view of a shutter piece according to a second embodiment of the present invention.

FIG. 24 is a bottom view of the shutter piece shown in FIG. 23.

FIG. 25 is a plan-side perspective view of combined shutter pieces each of which is shown in FIG. 23.

FIG. 26 is a bottom-side perspective view of combined shutter pieces each of which is shown in FIG. 23.

FIG. 27 is a schematic view showing a motion of the forming apparatus including the shutter piece shown in FIG. 23.

FIG. 28 is a schematic view showing a motion of the forming apparatus including the shutter piece shown in FIG. 23.

FIG. 29 is a schematic view showing a motion of the forming apparatus including the shutter piece shown in FIG. 23.

FIG. 30 is a schematic view showing a motion of the forming apparatus including the shutter piece shown in FIG. 23.

FIG. 31 is a schematic view showing a motion of the forming apparatus including the shutter piece shown in FIG. 23.

FIG. 32 is a schematic view showing a motion of the forming apparatus including the shutter piece shown in FIG. 23.

FIG. 33 is a schematic view showing a motion of the forming apparatus including the shutter piece shown in FIG. 23.

FIG. 34 is a schematic view showing a motion of the forming apparatus including the shutter piece shown in FIG. 23.

FIG. 35 is a schematic view showing a motion of the forming apparatus including the shutter piece shown in FIG. 23.

FIG. 36 is a schematic view showing a motion of the forming apparatus including the shutter piece shown in FIG. 23.

FIG. 37 is a schematic view showing a motion of the forming apparatus including the shutter piece shown in FIG. 23.

FIG. 38 is a plan-side perspective view of a shutter piece according to a first alternative of the present invention.

FIG. 39 is a plan-side perspective view of a shutter piece according to a second alternative of the present invention.

FIG. 40 is a plan view of a shutter piece according to a third embodiment of the present invention.

FIG. 41 is an opening-side side view of the shutter piece shown in FIG. 40.

FIG. 42 is a bottom view of the shutter piece shown in FIG. 40.

FIG. 43 is a perspective view of the shutter piece shown in FIG. 40.

FIG. 44 is a schematic view showing a motion of the forming apparatus including the shutter piece shown in FIG. 40.

FIG. 45 is a schematic view showing a motion of the forming apparatus including the shutter piece shown in FIG. 40.

FIG. 46 is a schematic view showing a motion of the forming apparatus including the shutter piece shown in FIG. 40.

FIG. 47 is a schematic view showing a motion of the forming apparatus including the shutter piece shown in FIG. 40.

FIG. 48 is a schematic view showing a motion of the forming apparatus including the shutter piece shown in FIG. 40.

### DESCRIPTION OF EMBODIMENTS

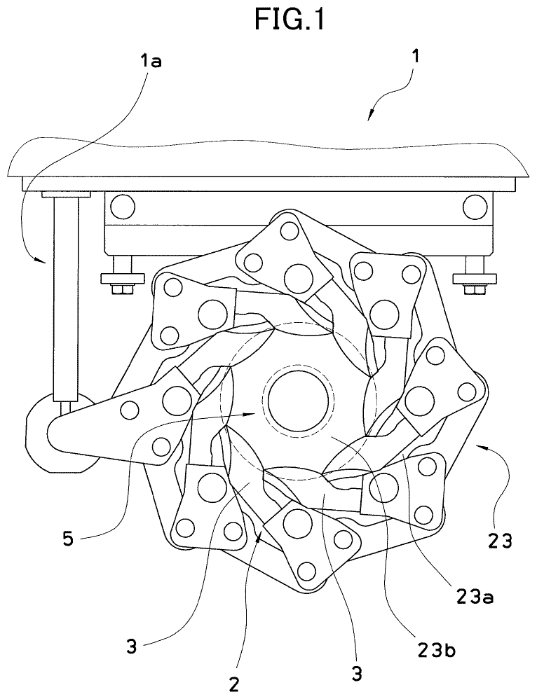

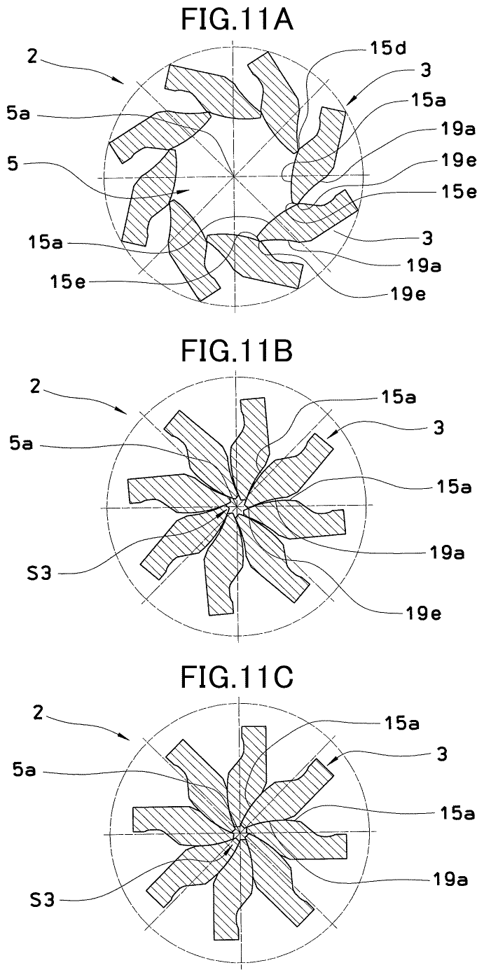

Referring to FIGS. 1-11, a shutter piece and a shutter set according to a first embodiment of the present invention will be explained.

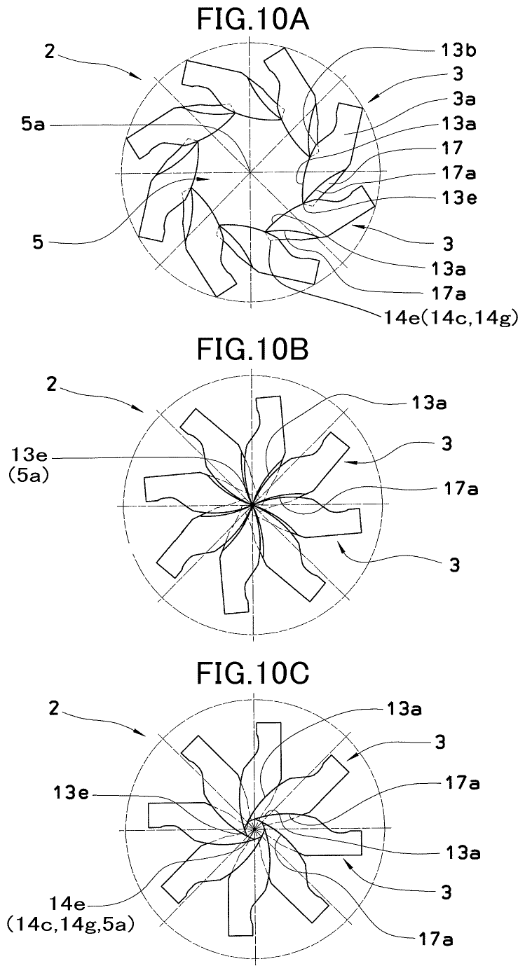

A shutter device 23 shown in FIG. 1 is a part of a forming apparatus 1 described later, and includes a base plate 23a, a hole plate 23b, a shutter set 2 constituted by circumferentially arranging eight shutter pieces 3 according to the first embodiment of the present invention, and a driving mechanism 1a for driving the shutter pieces 3. The shutter set 2 is configured to move between a fully-closed state (See, for example, FIG. 10C) and an opened state (See, for example, FIG. 10A) defining an opening 5 by synchronously swinging the eight shutter pieces 3. Since the drive mechanism 1a is, for example, a link mechanism connected to a drive motor (not shown) installed in the forming apparatus 1, and a detailed description thereof is omitted since it is conventionally known.

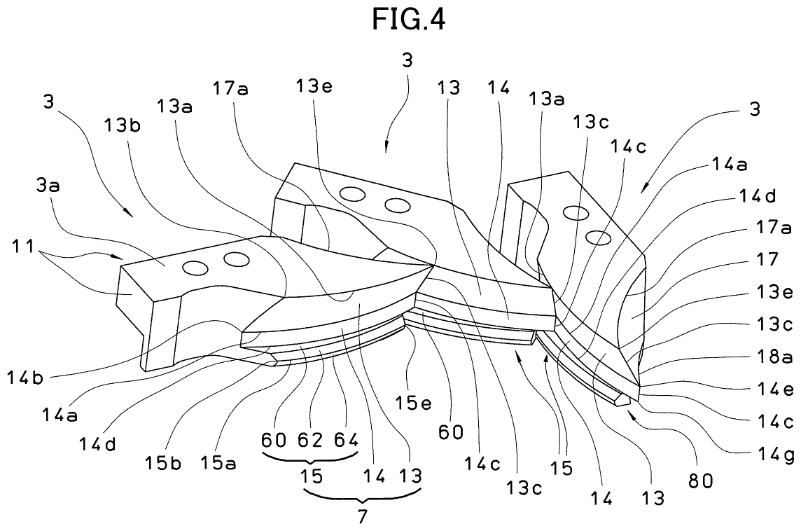

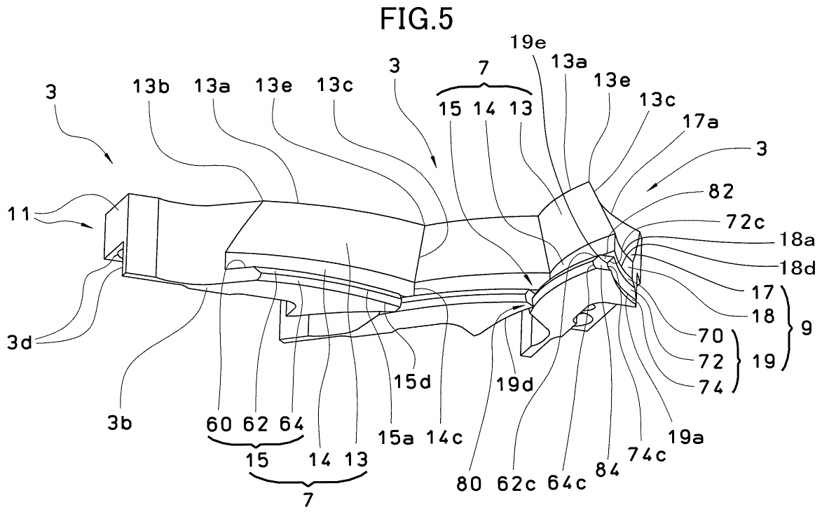

As shown in FIGS. 4 and 5, the shutter piece 3 has an upper surface 3a, a lower surface 3b, and side surfaces 7, 9, 11 located between the upper surface 3a and the lower surface 3b. The side surfaces 7, 9, 11 include an opening-side surface 7 defining the opening 5, an abutting-side surface 9 defining front-end edges 13c, 14c together with the opening-side surface 7, and the other side surfaces 11.

The lower surface 3b and other side surfaces 11 are provided with drive attachments 3d attached to the drive mechanism 1a, and the drive attachments 3d are, for example, recesses and holes, which detailed description is omitted since they are conventionally known.

The opening-side surface 7 has an upper portion 13, a lower portion 15 located below the upper portion 13, and an intermediate portion 14 located between the upper portion 13 and the lower portion 15.

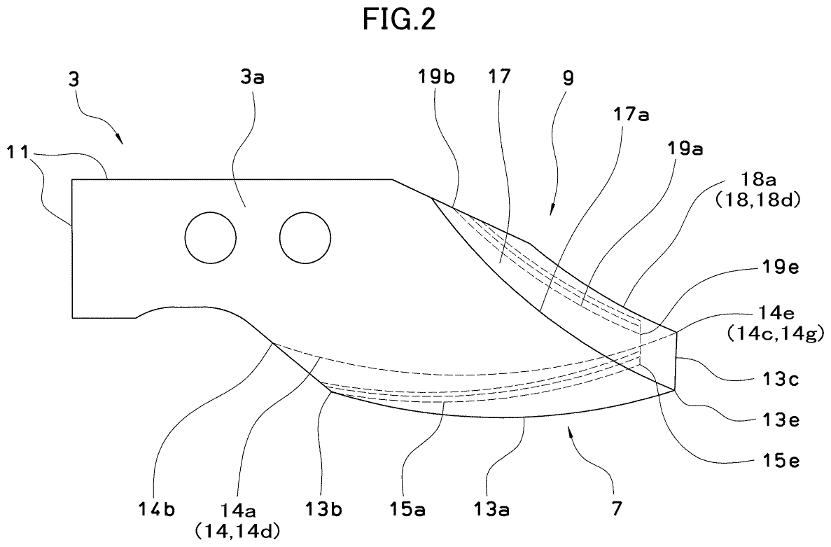

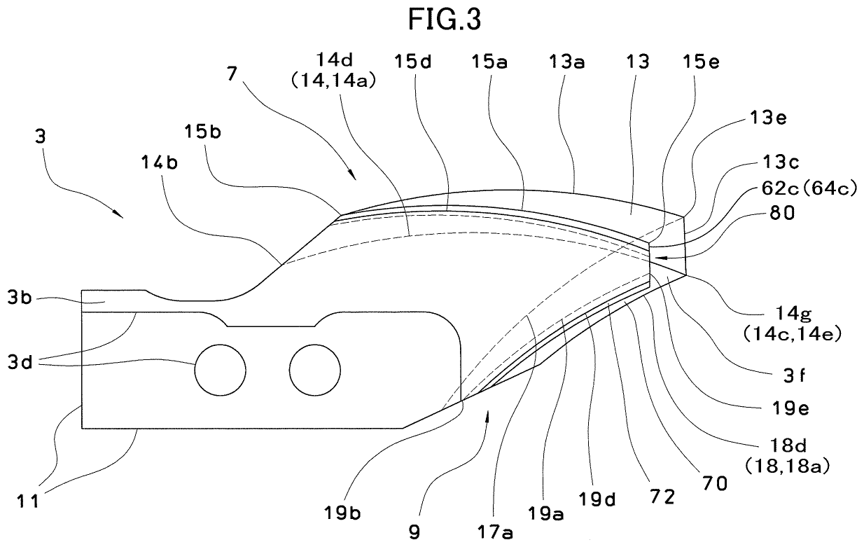

The upper portion 13 is mainly defined by an upper edge 13a, an intermediate edge 14a, and a front-end edge 13c, and extends obliquely downward from the upper edge 13a toward the intermediate edge 14a (intermediate portion 14) to be recessed from the upper edge 13a. In the plan view, the upper edge 13a is convex and arcuate, and extends from a base end 13b to a front end 13e (see FIGS. 2 and 3). In the plan view, the intermediate edge 14a is convex and arcuate, and extends from a base end 14b to a front-end 14e. The front-end edge 13c extends from the front end (upper end) 13e of the upper edge 13a to the front end (lower end) 14e of the intermediate edge 14a and is vertically inclined. The position of the front-end edge 13c is preferably determined to pass through a center 5a of the opening 5 of the shutter set 2 when the shutter piece 3 is swung (see FIGS. 10B and 10C).

A front-side portion of the intermediate portion 14 is mainly defined by the intermediate edge 14a, a lower intermediate edge 14d (lower end), and a front-end edge 14c, is a single surface connecting the intermediate edge 14a (lower edge of the upper portion 13) to the lower intermediate edge 14d (upper end of the lower portion 15), and vertically has the same contour. In the plan view, the lower intermediate edge 14d is convex and arcuate, and extends from a base end to a front end 14g. The front-end edge 14c extends linearly in the vertical direction from the front-end 14e (upper end, i.e., lower end of the front-end edge 13c) of the intermediate edge 14a to the front end 14g (lower end) of the lower intermediate edge 14d. The position of the front-end edge 14c is preferably determined to pass through the center 5a of the opening 5 of the shutter set 2 when the shutter piece 3 is swung (see FIG. 10C). In the plan view, a width between the upper edge 13a and the intermediate edge 14a becomes wider from the base end 14b to the front end 14e (the front-end edge 14c) (see FIGS. 2 and 3).

In the plan view as shown in FIG. 3, a front-side portion of the lower portion 15 is disposed to be recessed from the upper edge 13a, but to be protruded from the intermediate edge 14a and the lower intermediate edge 14d (the intermediate portion 14), and has a protruding edge 15a which is convex and arcuate. The protruding edge 15a extends from a base end 15b to a front end 15e. In the plan view, the front end 15e and the base end 15b are recessed toward the abutting-side surface 9 from the upper edge 13a and protruded toward the opening 5 from the intermediate edge 14a (lower intermediate edge 14d).

Specifically, as shown in FIGS. 4 and 5, the front-side portion of the lower portion 15 includes three surfaces, namely, a horizontal portion 60, an upper slope portion 62, and a lower slope portion 64. The horizontal portion 60 is an upward surface disposed along the lower intermediate edge 14d (intermediate portion 14) and horizontally extends to protrude from the lower intermediate edge 14d (intermediate portion 14). A width of the horizontal portion 60 horizontally protruding from the intermediate portion 14 becomes smaller from the base end 15b toward the front end 15e. The upper slope portion 62 extends obliquely downward to protrude from the horizontal portion 60. The lower slope portion 64 extends obliquely downward to the lower edge 15d (lower surface 3b) to be recessed from the upper slope portion 62. The convex protruding edge 15a is a peripheral edge of the lower portion 15 and is defined by a boundary line between the upper slope portion 62 and the lower slope portion 64. In the plan view, a width between the protruding edge 15a and the intermediate edge 14a becomes smaller from the base end 15b toward the front end 15e (see FIGS. 2 and 3).

The upper slope portion 62 is preferably an inclined surface extending obliquely upward from the protruding edge 15a, and a profile of a vertical section of the inclined surface may be a straight line, a convex or concave curved line, or a combination thereof. In this embodiment, the profile of the vertical section of the inclined surface of the upper slope portion 62 is a straight line. Further, the lower slope portion 64 is preferably an inclined surface extending obliquely downward from the protruding edge 15a, and a profile of a vertical section of the inclined surface may be a straight line, a convex curved line, or a combination thereof. In this embodiment, the profile of the vertical section of the inclined surface of the lower slope portion 64 is a convex curved line. In the plan view, the lower edge 15d where the lower slope portion 64 (lower portion 15) intersects the lower surface 3b extends in a convex and arcuate way (see FIG. 3).

As shown in FIG. 5, the lower portion 15 further has a front edge 62c on a front side of the upper slope portion 62, and a front edge 64c on a front side of the lower slope portion 64. The front end 15e of the convex protruding edge 15a is an intersection of the front edge 62c of the upper slope portion 62 and the front edge 64c of the lower slope portion 64.

Further, as shown in FIG. 3, in the plan view, the front edge 62c of the upper slope portion 62 and the front edge 64c of the lower slope portion 64 are not located at the front-end edge 13c of the upper portion 13 and the front-end edge 14c of the intermediate portion 14, i.e., they are offset toward the base end 15b of the protruding edge 15a so that they do not pass through the center 5a of the opening 5.

As shown in FIG. 5, the abutting-side surface 9 has an upper portion 17, an intermediate portion 18, and a lower portion 19. Further, the lower portion 19 includes a horizontal portion 70, an upper slope portion 72, and a lower slope portion 74.

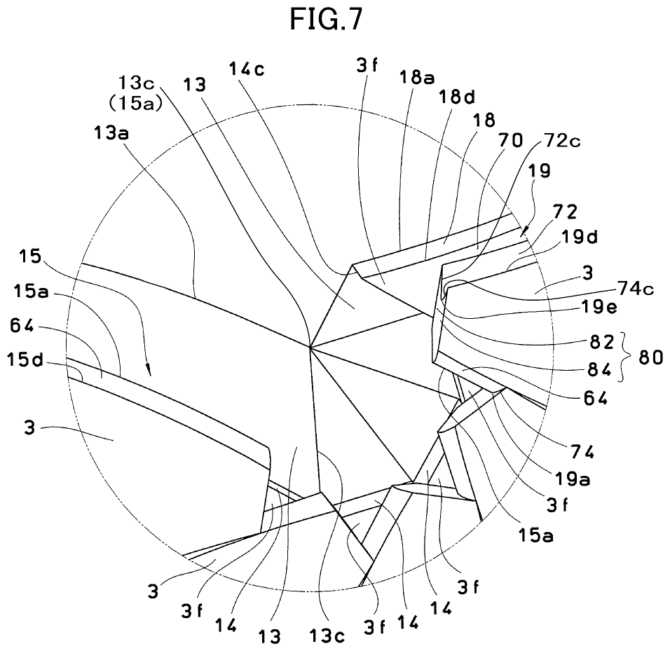

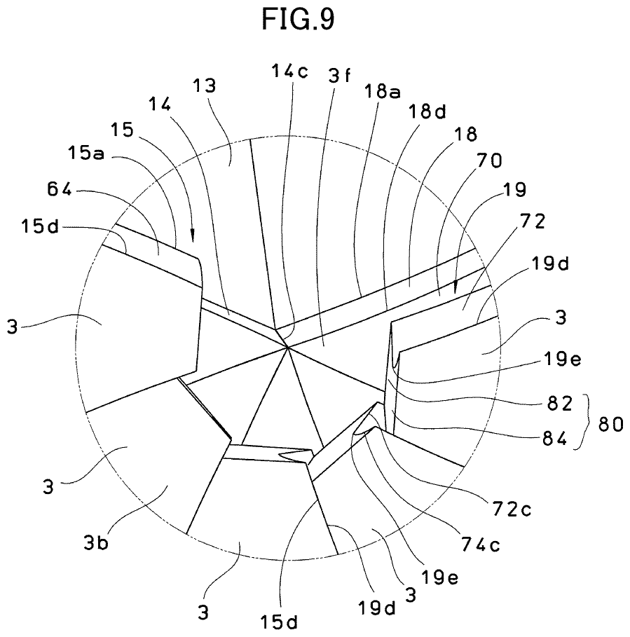

As shown in FIGS. 2-5, the upper portion 17 is mainly defined by an upper edge 17a, an intermediate edge 18a, and the front-end edge 13c which is common to the upper portion 13 of the opening-side surface 7. The intermediate portion 18 is mainly defined by the intermediate edge 18a, a lower intermediate edge 18d, and the front-end edge 14c which is common to the intermediate portion 14 of the opening-side surface 7 (see FIG. 7). The horizontal portion 70 of the lower portion 19 is a downward surface horizontally extending to be recessed from the lower intermediate edge 18d. The upper slope portion 72 extends obliquely downward to be recessed from the horizontal portion 70 and has a front edge 72c on its front side. The lower slope portion 74 extends obliquely downward to a lower edge 19d (lower surface 3b) to protrude from the upper slope portion 72 and has a front edge 74c on its front side. A recessed edge 19a between the upper slope portion 72 and the lower slope portion 74 extends from a base end 19b to a front end 19e, and the front end 19e is an intersection of the front edge 72c of the upper slope portion 72 and the front edge 74c of the lower slope portion 74 (see FIGS. 3 and 9).

Preferably, the front-end edge 13c, the front-end edge 14c, and the front edges 72c, 74c always abut the upper portion 13, the intermediate portion 14, and the upper and lower slope portions 62, 64 of the lower portion 15 of the opening-side surface 7 of the adjacent shutter piece 3, respectively, without substantially causing any clearance when the shutter piece 3 is swung.

Further, a front portion of the lower intermediate edge 14d of the intermediate portion 14 of the opening-side surface 7 is preferably formed so that when the front portion of the lower intermediate edge 14d is located on the horizontal portion 60 of the lower portion 15 of the opening-side surface 7 in the adjacent shutter piece 3, the front portion always abuts the horizontal portion 60 without substantially causing any clearance (see FIGS. 4 and 5).

In the following explanation, states when the front end 13e (upper end) and the front-end 14e (lower end) of the front-end edge 13c of the upper portion 13 of the opening-side surface 7 are located at the center 5a of the opening 5 are referred to as a “starting closing state” and a “fully-closed state” of the shutter set, respectively. In this embodiment, in the fully-closed state, the front-end edge 14c of the intermediate portion 14 of the opening-side surface 7 is also located at the center 5a of the opening 5.

The upper portion 17, the intermediate portion 18 and the lower portion 19 of the abutting-side surface 9 are preferably formed in a concave shape to abut the upper portion 13, the intermediate portion 14 and the lower portion 15 of the opening-side surface 7 of the adjacent shutter piece, respectively, when the shutter set 2 is in the fully-closed state.

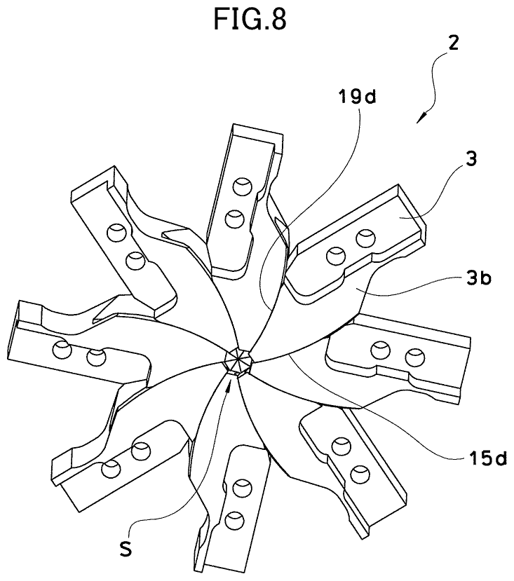

Specifically, the upper edge 13a and the intermediate edge 14a of the upper portion 13 of the opening-side surface 7 can abut the upper edge 17a and the intermediate edge 18a of the upper portion 17 of the abutting-side surface 9 of the adjacent shutter piece 3, respectively (see FIG. 10C). The intermediate edge 14a and the lower intermediate edge 14d of the intermediate portion 14 of the opening-side surface 7 can abut the intermediate edge 18a and the lower intermediate edge 18d of the intermediate portion 18 of the abutting-side surface 9 of the adjacent shutter piece 3, respectively. The protruding edge 15a and the lower edge 15d of the lower portion 15 of the opening-side surface 7 can abut the recessed edge 19a and the lower edge 19d of the lower portion 19 of the abutting-side surface 9 of the adjacent shutter piece 3, respectively (see FIG. 8). Namely, in the plan view, each of the upper edge 17a, the intermediate edge 18a, the lower intermediate edge 18d, the recessed edge 19a, and the lower edge 19d of the abutting-side surface 9 is formed to be concave and arcuate.

Further, in a plan view, the front edge 72c of the upper slope portion 72 and the front edge 74c of the lower slope portion 74 are not located at the front-end edge 13c of the upper portion 17 and the front-end edge 14c of the intermediate portion 18, namely, they are offset toward the base edge 19b of the recessed edge 19a so that they do not pass through the center 5a of the opening 5.

The shutter piece 3 has a front-end surface 80 below the front-end edge 14c which is offset closer to the base-end 14b than the front-end edge 14c. The front-end surface 80 is a combination of an upper front-end surface 82 and a lower front-end surface 84 (see FIG. 7). The upper front-end surface 82 is a substantially quadrangular surface with opposite sides, namely, the front edge 62c of the upper slope portion 62 of the opening-side surface 7 and the front edge 72c of the upper slope portion 72 of the abutting-side surface 9. Further, the lower front-end surface 84 is a substantially quadrangular surface with opposite sides, namely, the front edge 64c of the lower slope portion 64 of the opening-side surface 7 and the front edge 74c of the lower slope portion 74 of the abutting-side surface 9. The front-end surface 80 is formed so as to intersect the lower portions 15, 19 on the front-end side of the lower portions 15, 19. Further, the shutter piece 3 has a downward horizontal surface extending from an upper end of the front-end surface 80 toward the front-end side of the shutter piece 3. When the shutter piece 3 is viewed from its bottom, a planar intermediate lower surface 3f, which includes this horizontal surface and a horizontal portion 70 of the lower portion 19, is formed on the front side of the shutter piece 3 (see FIGS. 5 and 7).

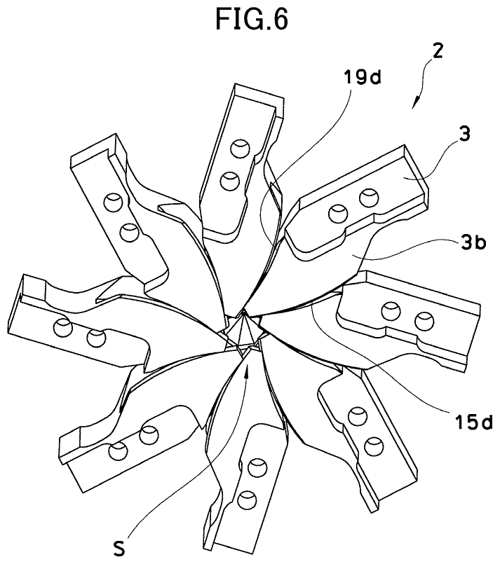

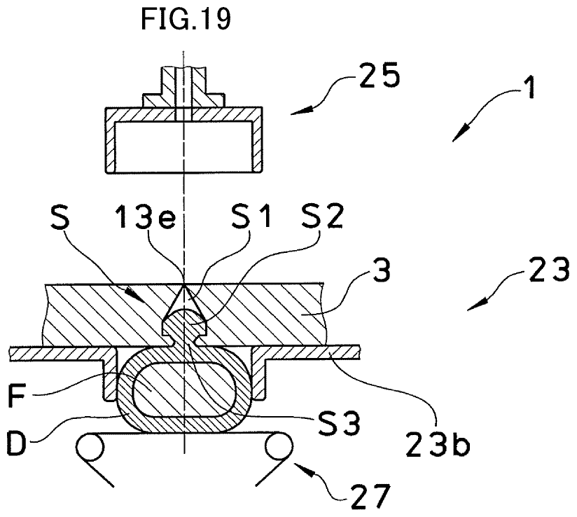

As shown in FIGS. 6, 7 and 10B, locating the front end 13e of the upper edge 13a of the opening-side surface 7 of the shutter piece 3 at the center 5a of the opening 5 causes a state in which the opening 5 of the shutter set 2 is closed by the front ends 13e (the starting closing state). At this time, the front-end edges 13c, 14c, the front edges 72c, 74c, and the front portion of the lower intermediate edge 14d of the shutter piece 3 abut the upper portion 13, the intermediate portion 14, and the lower portion 15 of the opening-side surface 7 of the adjacent shutter piece 3, respectively. Thus, on the opening-side surface 7 of each shutter piece 3, a ceiling space S with concaveness and convexness is formed and surrounded by the inclined upper portion 13, the vertically-extending intermediate portion 14, the lower portion 15 protruding toward the opening 5, the front-end surface 80 offset from the front end toward the base end of the shutter piece 3, and the lower portion 19 and the intermediate lower surface 3f continuous to the front-end surface 80. The ceiling space S is defined in a top-down order by a first space S1 with a substantially octagonal pyramid surrounded by the eight upper portions 13, a second space S2 with a substantially octagonal prism surrounded by the eight intermediate portions 14, and the remaining third space S3 (see FIG. 19).

While the shutter set 2 is moved from the starting closing state to the fully-closed state shown in FIGS. 8, 9 and 10C, the ceiling space S is entirely reduced. Specifically, a height and a diameter of the first space S1 are reduced, and a diameter of the second space S2 is reduced.

As a result, when the shutter set 2 reaches the fully-closed state, the first space S1 and the second space S2 have not existed, so that the ceiling space S is defined only by the reduced third space S3 (see FIG. 21). Specifically, a ceiling of the third space S3 is defined by the intermediate lower surfaces 3f on the front side of the eight shutter pieces 3, while the remaining of the third space S3 is surrounded by the eight front-end surfaces 80 offset from the front-end edges 13c, 14c toward the base side, and the lower portion 19 continuous to the front-end surface 80.

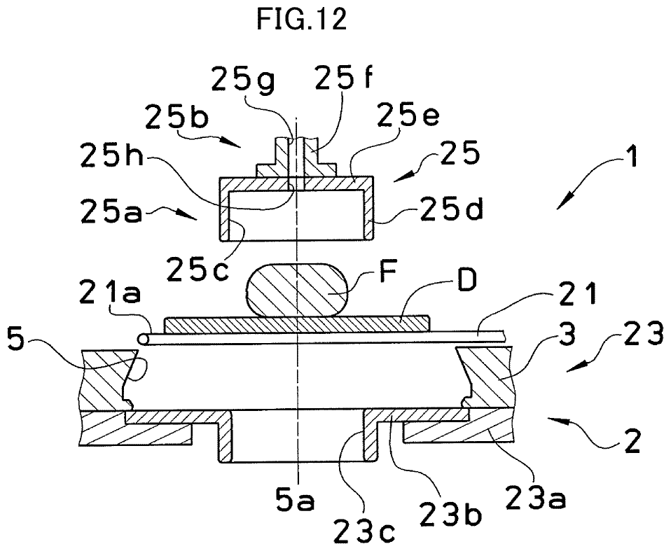

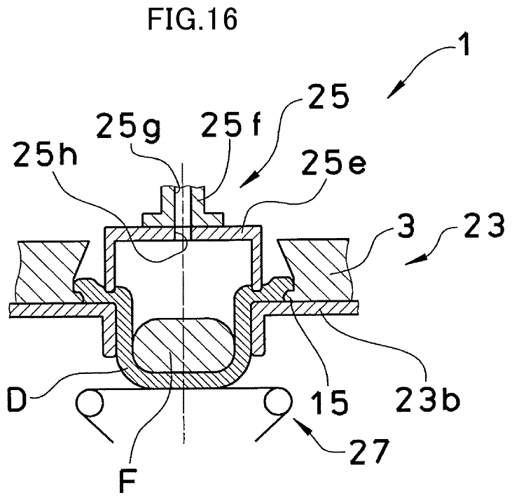

Next, referring to FIGS. 12 and 16, an exemplary forming apparatus using a shutter device including a shutter set will be schematically explained.

The forming apparatus 1 is used for forming an enveloped food product P in which an inner material F is enveloped by an outer skin material D. Regarding the forming apparatus 1, portions relating to the present invention will be mainly explained, while explanations of the other portions conventionally known will be omitted.

The forming apparatus 1 includes a supply conveyor device 21 for supplying a disk-like outer skin material D on which an inner material F is deposited, a shutter device 23 located below the supply conveyor device 21, a press device 25 located above the supply conveyor device 21, and a support device 27 located below the shutter device 23, which devices are controlled by a controller (not shown).

The supply conveyor device 21 includes a front-end portion 21a which is extensible and retractable between an extended position and a standby position.

The shutter device 23 includes a base plate 23a, a hole plate (placing member) 23b for supporting the outer skin material D supplied from the supply conveyor device 21, and a shutter set 2 swinging and sliding on the hole plate 23b. The hole plate 23b has a circular central opening 23c. A size of a diameter and a thickness (height) of the central opening 23c are appropriately selected according to the enveloped food product P to be formed.

The press device 25 includes a press member 25a and a raising and lowering device 25b for raising and lowering the press member 25a. The press member 25a is in a cup shape with a downward opening 25c and has an annular peripheral wall 25d and a ceiling part 25e disposed on an upper part of the peripheral wall 25d. In the present embodiment, the raising and lowering device 25b includes a piston rod 25f moving upward and downward, and the piston rod 25f has a through hole 25g for supplying compressed air downward. The ceiling part 25e has a through hole 25h communicating with the through hole 25g of the piston rod 25f.

The support device 27 is defined by a belt conveyor and allowed to be raised and lowered.

Next, referring to FIGS. 12-22, an operation of the forming apparatus 1 will be explained.

As shown in FIG. 12, the disk-like outer skin material D on which the inner material F is deposited is conveyed by the supply conveyor device 21 to a position where a center of the outer skin material D corresponds to the center 5a of the opening 5 of the shutter set 2, namely, a center of the opening 23c of the hole plate 23b. The front-end portion 21a of the supply conveyor device 21 is in the extended position.

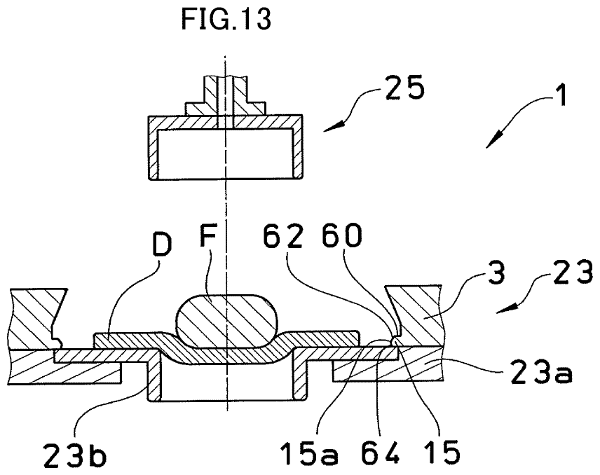

As shown in FIG. 13, the front-end portion 21a of the supply conveyor device 21 is retracted from the extended position to the standby position, so that the outer skin material D and the inner material F are placed onto the hole plate 23b.

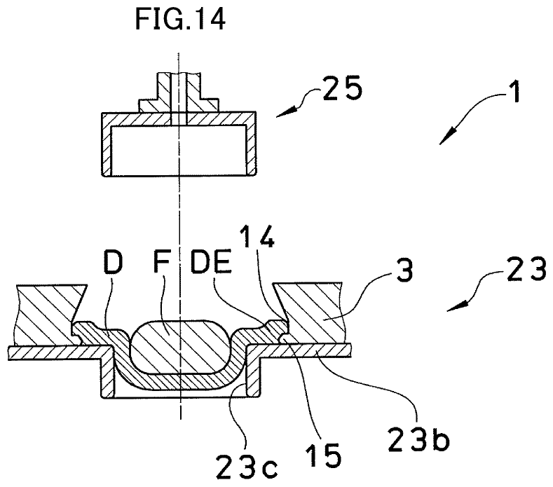

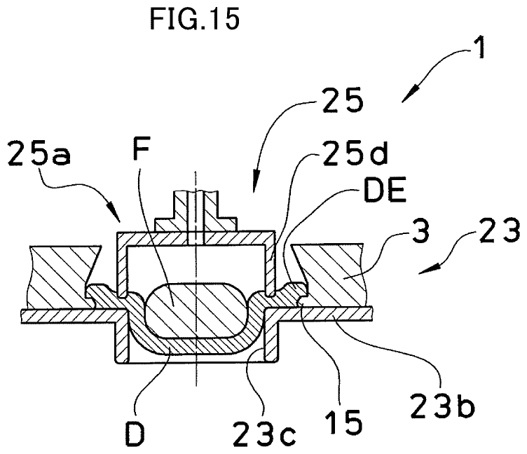

As shown in FIG. 14, the shutter device 23 is actuated to move the shutter set 2 toward the closed state. On the opening-side surface 7 of the shutter piece 3, the protruding edge 15a of the lower portion 15 is allowed to contact the peripheral edge portion DE of the outer skin material D, and then, the upper slope portion 62 and the horizontal portion 60 are allowed to get under a lower surface of the peripheral edge DE. Further, after the intermediate portion 14 is allowed to contact a peripheral edge of the outer skin material D, a closing action of the shutter set 2 is temporarily stopped. This allows an amount of the peripheral edge portion DE required for a sealing operation to evenly remain on the hole plate 23b. Further, a portion of the outer skin material D around its center is pushed from the peripheral edge by the shutter set 2 and recessed into the opening 23c of the hole plate 23b due to the own weights of the outer skin material D and the inner material F.

As shown in FIG. 15, the press member 25a of the press device 25 is lowered and stopped at an appropriate lowered position depending on, for example, a thickness and hardness of the outer skin material D. The peripheral edge portion DE of the outer skin material D is pressed by the annular peripheral wall 25d of the press member 25a against the hole plate 23b to seal an inner space defined between the outer skin material D and the press member 25a.

As shown in FIG. 16, by supplying compressed air from the through hole 25h into the inner space, the outer skin material D is expanded downward inside of the opening 23c to form a bowl-like shape. A bottom portion of the downward expanded outer skin material D is supported by the support device 27 to prevent the outer skin material D from being deformed more than required and stabilize a shape of the outer skin material D. At that time, a position of the support device 27 allows a position of a head of the inner material F to be determined relative to an upper surface of the hole plate 23b. The position of the head of the inner material F is preferably the same as or lower than the hole plate 23b.

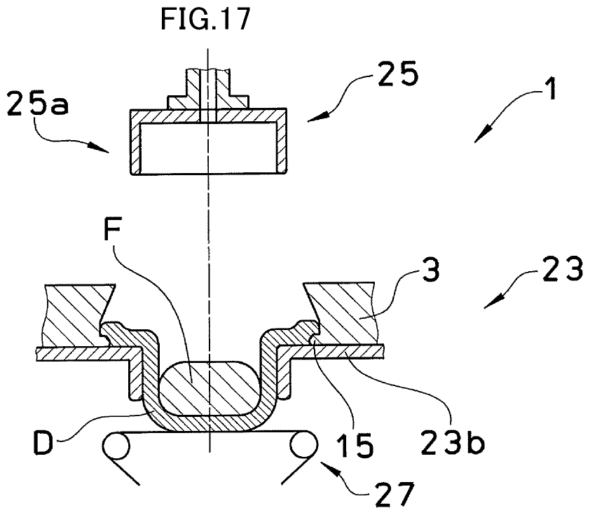

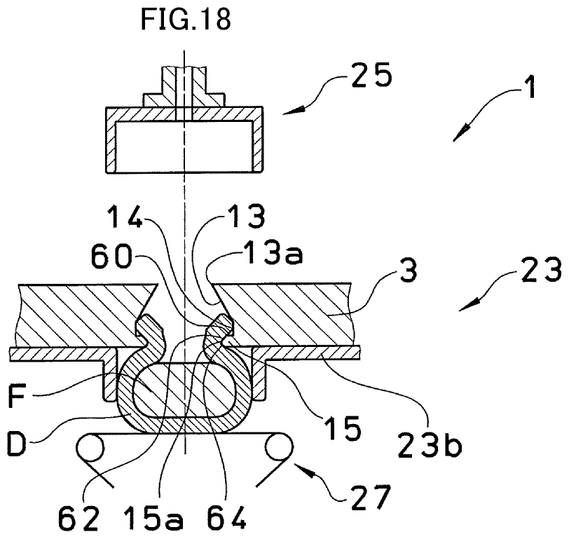

As shown in FIG. 17, the press member 25a is raised. As shown in FIG. 18, the shutter set 2 is moved toward the closed state again. The lower portion 15 of the shutter piece 3 allows the outer skin material D near the inner material F to be concentrically gathered and stretched toward a position above a center of the inner material F. Since the horizontal portion 60 is configured to protrude from the intermediate portion 14 toward the opening 5, a force for holding the outer skin material D can be enhanced so that the gathering effect can be further enhanced. Further, since the lower slope portion 64 of the lower portion 15 is formed to be inclined toward the abutting side surface 9 in a fan-like shape, roughening (scratching) on the surface of the outer skin material D can be prevented. In the present embodiment, since the profile of the vertical section of the inclined surface of the lower slope portion 64 is formed of a convex curved surface, the effect of preventing the roughening of the surface can be further enhanced.

The closing action of the shutter set 2 is forwarded, and the inner material F is enveloped to be sealed by the outer skin material D surrounded by the eight lower portions 15 at a position above the inner material F. As shown in FIG. 19, the closing action of the shutter set 2 is further forwarded so that the front end 13e is located at the center 5a, and this allows the opening 5 of the shutter set 2 to be closed to form the ceiling space S. As a result, it is possible to prevent the outer skin material D from leaking onto the upper surface 3a of the shutter piece 3, namely, onto the upper surface of the shutter set 2.

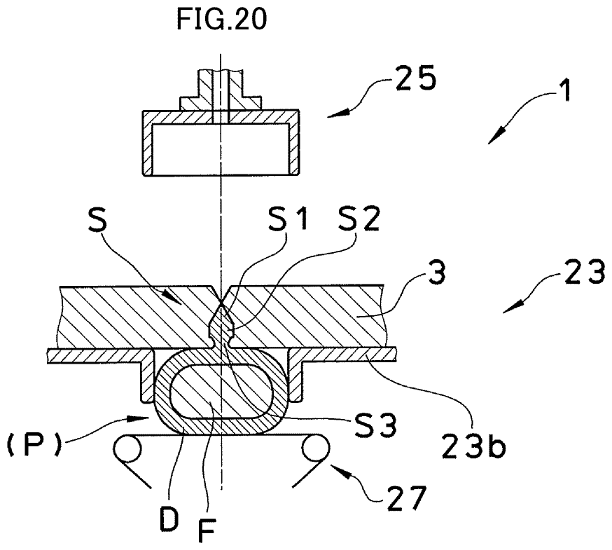

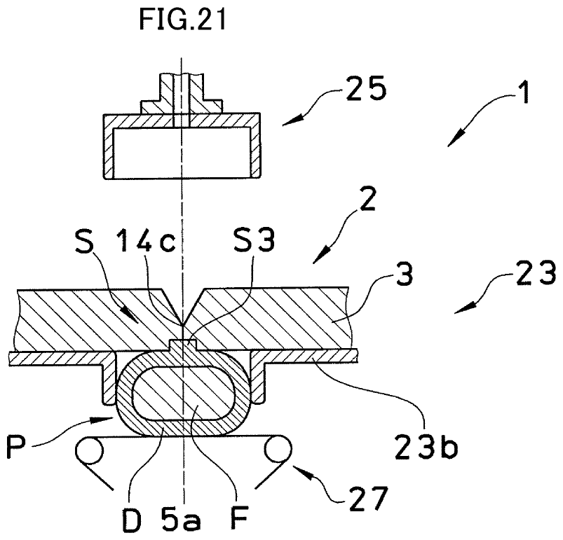

As shown in FIG. 20, as the closing action of the shutter set 2 is forwarded, a volume of the ceiling space S is reduced. Since a diameter of the third space S3 of the ceiling space S is smaller than a diameter of the second space S2 located above the third space S3, the third space S3 assumes a role of a squeezing valve for the outer skin material D pushed out from an inside of the ceiling space S. As a result, the outer skin material D remaining inside of the ceiling space S is subject to a strong pressure from the shutter set 2, and at the same time, pushed out through the gradually-reduced third space S3, so that the peripheral edge portion DE of the outer skin material D is firmly attached and sealed to itself.

Further, a width of the lower portion 15 horizontally protruding from the intermediate portion 14 becomes smaller from the base end 15b toward the front end 15e. Thus, as the ceiling space S is gradually reduced, the protruding width of the lower portion 15 becomes smaller, so that the third space S3 is not closed and the opening can be maintained.

As shown in FIG. 21, the shutter set 2 is moved to the fully-closed state, the closing action of the shutter set (unit) 2 is stopped, and the attaching and sealing operation of the outer skin material D due to the shutter set (unit) 2 is finished. At this time, the ceiling space S exists only at the reduced third space S3, as explained above. Alternatively, if the outer skin material D can be attached and sealed to itself, the shutter set 2 may not be moved to the fully-closed state. In this case, the ceiling space S is formed by the first space S1, the second space S2, and the third space S3, and the outer skin material D is stored in the ceiling space S, so that an amount of the outer skin material D gathered to an upper central portion of the enveloped food material P increases. Thus, a top of the enveloped food product P is prevented from being recessed because when the outer skin material D in the upper central portion of the enveloped food material P is stretched toward a periphery to its elasticity, the stored outer skin material D is extended (see FIG. 20).

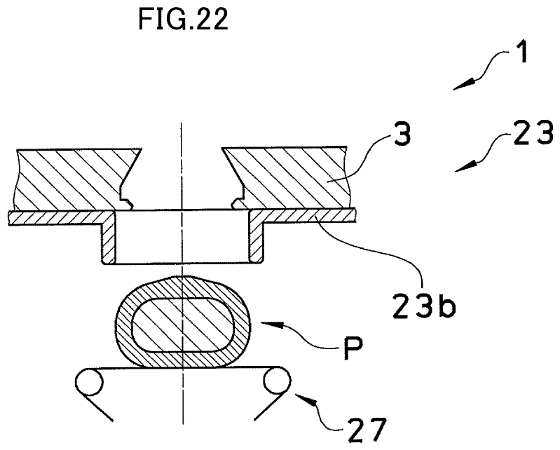

As shown in FIG. 22, the shutter set 2 is moved toward the opened state, the outer skin material D of the head of the enveloped food product P is released, and the support device 27 on which the enveloped food product P is deposited is lowered.

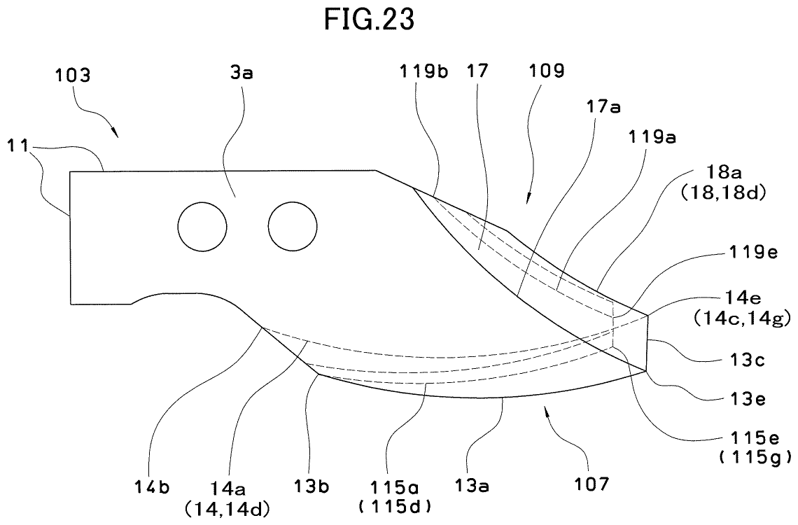

Next, referring to FIGS. 23-26, a shutter piece and a shutter set according to a second embodiment of the present invention will be explained.

A shutter piece 103 of the second embodiment according to the present invention has a structure which is similar to that of the shutter piece 3 of the first embodiment, but is different mainly from the lower portions 15, 19 and the front-end surface 80 of the shutter piece 3. Components of the shutter piece 103 according to the second embodiment, which are similar to those of the shutter piece 3 according to the first embodiment, have the same reference numerals as those of the shutter piece 3, and their detailed explanation is omitted.

An opening-side surface 107 of the shutter piece 103 includes the upper portion 13, the intermediate portion 14, and a lower portion 115.

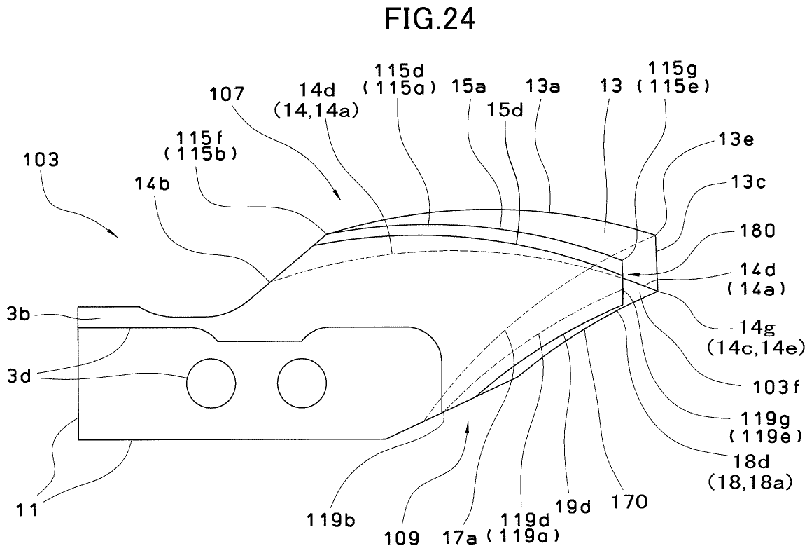

In the plan view as shown in FIG. 24, a front-side portion of the lower portion 115 is disposed to be recessed from the upper edge 13a, but to be protruded from the intermediate edge 14a and the lower intermediate edge 14d (the intermediate portion 14), and has a protruding edge 115a which is convex and arcuate. The protruding edge 115a extends from a base end 115b to a front end 115e. In the plan view, the protruding edge 115a is located between the upper edge 13a and the intermediate edge 14a (lower intermediate edge 14d). In the plan view, the front end 115e and the base end 115b are recessed toward the abutting-side surface 9 from the upper edge 13a and protruded toward the opening 5 from the intermediate edge 14a (lower intermediate edge 14d).

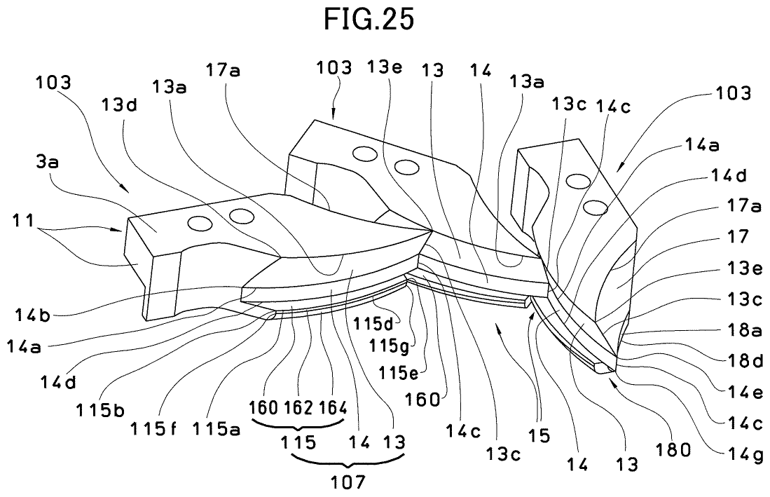

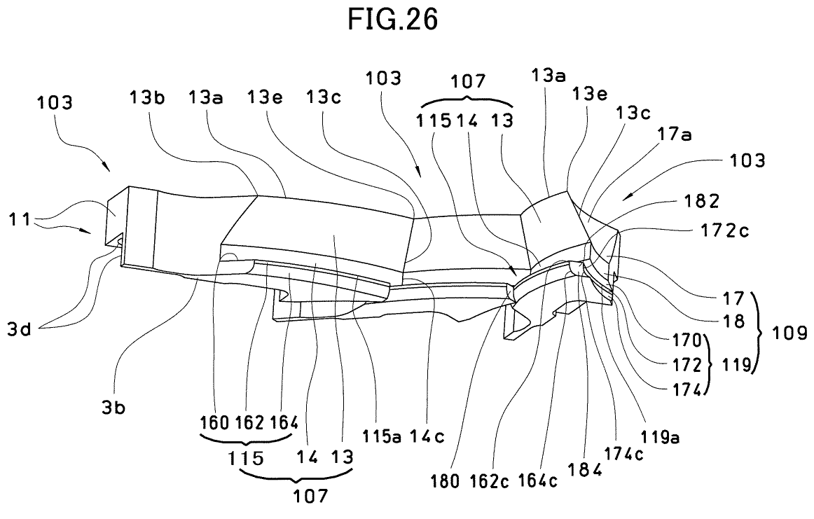

Specifically, as shown in FIGS. 25 and 26, the front-side portion of the lower portion 115 includes three surfaces, namely, a horizontal portion 160, a vertical portion 162, and a lower slope portion 164. The horizontal portion 160 is an upward surface disposed along the lower intermediate edge 14d (intermediate portion 14) and horizontally extends to protrude from the lower intermediate edge 14d (intermediate portion 14). A width of the lower portion 115 horizontally protruding from the intermediate portion 14 becomes smaller from the base end 115b toward the front end 115e. The vertical portion 162 downwardly extends from and orthogonal to the horizontal portion 160. The lower slope portion 164 extends obliquely downward to the lower edge 15d (lower surface 3b) to be recessed from the vertical portion 162. The convex protruding edge 115a is a peripheral edge of the lower portion 115 and is defined by a boundary line between the horizontal portion 160 and the vertical portion 162. In the plan view, a width between the protruding edge 115a and the intermediate edge 14a becomes smaller from the base end 115b toward the front end 115e (see FIGS. 23 and 24).

The vertical portion 162 is preferably a curved surface extending downward from the protruding edge 115a to a lower protruding edge 115d, and vertically has the same contour. The lower protruding edge 115d extends from a base end 115f to a front end 115g. Further, the lower slope portion 164 is preferably an inclined surface extending obliquely downward from the lower protruding edge 115d of the vertical portion 162, and a profile of a vertical section of this inclined surface may be a straight line, a convex curved line, or a combination thereof. In this embodiment, the profile of the vertical section of the inclined surface of the lower slope portion 64 is a convex curved line. In the plan view, the lower edge 15d where the lower slope portion 164 intersects the lower surface 3b extends in a convex and arcuate way (see FIG. 24).

As shown in FIG. 26, the lower portion 115 further has a front edge 162c on a front side of the vertical portion 162 and a front edge 164c on a front side of the lower slope portion 164. The front end 115g of the above-stated lower protruding edge 115d is an intersection of the front edge 162c of the vertical portion 162 and the front edge 164c of the lower slope portion 164.

As shown in FIG. 24, in the plan view, the front edge 162c of the vertical portion 162 and the front edge 164c of the lower slope portion 164 are not located at the front-end edge 13c of the upper portion 13 and the front-end edge 14c of the intermediate portion 14, namely, they are offset toward the base end 115f of the protruding edge 115a so that they do not pass through the center 5a of the opening 5.

As shown in FIG. 26, an abutting-side surface 109 of the shutter piece 103 has the upper portion 17, the intermediate portion 18, and a lower portion 119. Further, the lower portion 119 includes a horizontal portion 170, a vertical portion 172, and a lower slope portion 174.

As shown in FIGS. 23-26, the horizontal portion 170 of the lower portion 115 is a downward surface that horizontally extends to be recessed from the lower intermediate edge 18d. The vertical portion 172 extends downward from and orthogonal to the horizontal portion 170 and has a front edge 172c on its front side. The lower slope portion 174 extends obliquely downward to the lower edge 19d (lower face 3b) to protrude from the vertical portion 172 and has a front edge 174c on its front side. A recessed edge 119a between the horizontal portion 170 and the vertical portion 172 extends from a base end 119b to a front end 119e, and the front end 119e is an intersection of the front edge 170c of the horizontal portion 170 and the front edge 172c of the vertical portion 172. A lower recessed edge 119d between the vertical portion 172 and the lower slope portion 174 extends from a base end 119f to a front end 119g, and the front end 119g is an intersection of the front edge 172c of the vertical portion 172 and the front edge 174c of the lower slope portion 174.

Preferably, the front-end edge 13c, the front-end edge 14c, and the front edges 172c, 174c are formed to always abut the upper portion 13, the intermediate portion 14, and the vertical and lower slope portions 162, 164 of the lower portion 115 of the opening-side surface 107 of the adjacent shutter piece 103, respectively, without substantially causing any clearance when the shutter piece 103 is swung. Namely, each of the upper edge 17a, the intermediate edge 18a, the lower intermediate edge 118d, the recessed edge 119a, the lower recessed edge 119d, and the lower edge 19d of the abutting side surface 109 is formed to be concave and arcuate in the plan view.

Further, a front portion of the lower intermediate edge 14d of the intermediate portion 14 of the opening-side surface 107 is preferably formed so that when the front portion of the lower intermediate edge 14d is located on the horizontal portion 160 of the lower portion 115 of the opening-side surface 107 in the adjacent shutter piece 103, the front portion always abuts the horizontal portion 160 without substantially causing any clearance (see FIGS. 25 and 26).

The upper portion 17, the intermediate portion 18 and the lower portion 119 of the abutting-side surface 109 are preferably formed in a concave shape to abut the upper portion 13, the intermediate portion 14 and the lower portion 115 of the opening-side surface 107 of the adjacent shutter piece, respectively, when the shutter set 102 is in the fully-closed state.

Specifically, the upper edge 13a and the intermediate edge 14a of the upper portion 13 of the opening-side surface 107 can abut the upper edge 17a and the intermediate edge 18a of the upper portion 17 of the abutting-side surface 109 of the adjacent shutter piece 103, respectively. The intermediate edge 14a and the lower intermediate edge 14d of the intermediate portion 14 of the opening-side surface 107 can abut the intermediate edge 18a and the lower intermediate edge 18d of the abutting-side surface 109 of the adjacent shutter piece 103, respectively. The protruding edge 115a and the lower protruding edge 115d of the vertical portion 162 and the lower edge 15d of the lower slope portion 164 of the lower portion 115 of the opening-side surface 107 can abut the recessed edge 119a and the lower recessed edge 119d of the vertical portion 172 and the lower edge 19d of the lower slope portion 164 of the abutting-side surface 109 of the adjacent shutter piece 103, respectively. Namely, in the plan view, each of the upper edge 17a, the intermediate edge 18a, the lower intermediate edge 18d, the recessed edge 119a, the lower recessed edge 119d, and the lower edge 19d of the abutting-side surface 109 is formed to be concave and arcuate.

Further, in a plan view, the front edge 172c of the vertical portion 172 and the front edge 174c of the lower slope portion 174 are not located at the front-end edge 13c of the upper portion 17 and the front-end edge 14c of the intermediate portion 18, namely, they are offset toward the base edge 119b of the recessed edge 119a so that they do not pass through the center 5a of the opening 5.

The shutter piece 103 has a front-end surface 180 below the front-end edge 14c which is offset closer to the base-end 14b than the front-end edge 14c. The front-end surface 180 is a combination of an upper front-end surface 182 and a lower front-end surface 184 (see FIG. 26). The upper front-end surface 182 is a substantially quadrangular surface with opposite sides, namely, the front edge 162c of the vertical portion 162 of the opening-side surface 107 and the front edge 172c of the vertical portion 172 of the abutting-side surface 109. Further, the lower front-end surface 184 is a substantially quadrangular surface with opposite sides, namely, the front edge 164c of the lower slope portion 164 of the opening-side surface 107 and the front edge 174c of the lower slope portion 174 of the abutting-side surface 109. The front-end surface 180 is formed so as to intersect the lower portions 115, 119 on the front-end side of the lower portions 115, 119. Further, the shutter piece 103 has a downward horizontal surface extending from an upper end of the front-end surface 180 toward the front-end side of the shutter piece 103. When the shutter piece 103 is viewed from its bottom, a planar intermediate lower surface 103f, which includes this horizontal surface and a horizontal portion 170 of the lower portion 119, is formed on the front side of the shutter piece 103 (see FIG. 26).

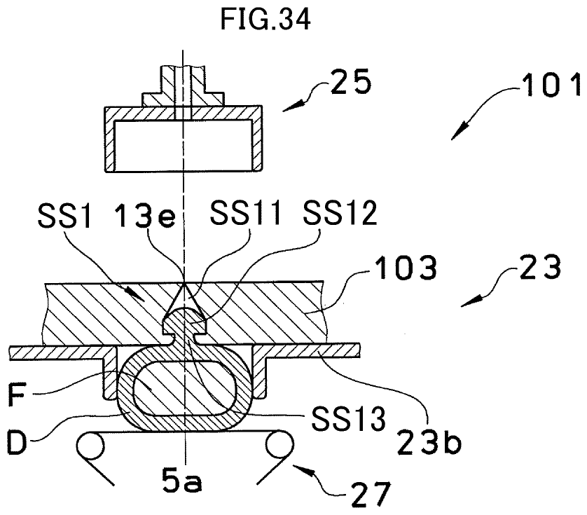

Locating the front end 13e of the upper edge 13a of the opening-side surface 107 of the shutter piece 103 at the center 5a of the opening 5 causes a state in which the opening 5 of the shutter set 102 is closed by the front end 13e (the starting closing state) (see FIG. 34). At this time, the front-end edges 13c, 14c, the front edges 172c, 174c, and the front-side portion of the lower intermediate edge 14d of the shutter piece 103 abut the upper portion 13, the intermediate portion 14, and the lower portion 115 of the opening-side surface 107 of the adjacent shutter piece 103, respectively. Thus, on the opening-side surface 107 of each shutter piece 103, a ceiling space SS1 with concaveness and convexness is formed and surrounded by the inclined upper portion 13, the vertically-extending intermediate portion 14, the lower portion 115 protruding toward the opening 5, the front-end surface 180 offset from the front end toward the base end of the shutter piece 103, and the lower portion 119 and the intermediate lower surface 103f continuous to the front-end surface 180. The ceiling space SS1 is defined in a top-down order by a first space SS11 with a substantially octagonal pyramid surrounded by the eight upper portions 13, a second space SS12 with a substantially octagonal prism surrounded by the eight intermediate portions 14, and the remaining third space SS13.

While the shutter set 102 is moved from the starting closing state to the fully-closed state (see FIG. 36), the ceiling space SS1 is entirely reduced. Specifically, a height and a diameter of the first space SS11 are reduced, and a diameter of the second space SS12 is reduced.

As a result, when the shutter set 102 reaches the fully-closed state, the first space SS11 and the second space SS12 have not existed, so that the ceiling space SS1 is defined only by the reduced third space SS13. Specifically, a ceiling of the third space SS13 is defined by the intermediate lower surfaces 103f on the front side of the eight shutter pieces 103, while the remaining of the third space SS13 is surrounded by the eight front-end surfaces 180 offset from the front-end edges 13c, 14c toward the base-end side, and the lower portion 119 continuous to the front-end surface 180.

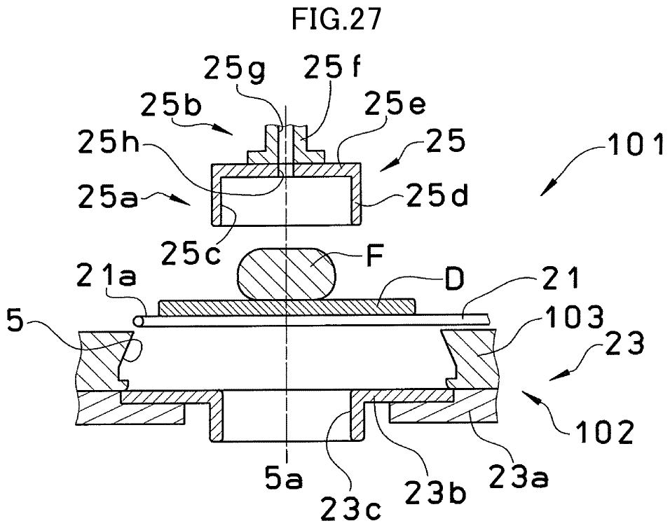

Next, referring to FIGS. 27-37, an operation of the forming apparatus 101 will be explained. Detailed explanation of portions of the operation of the forming apparatus 101 according to the second embodiment which are similar to portions of the operation of the forming apparatus 1 according to the first embodiment is omitted.

As shown in FIG. 27, the disk-like outer skin material D on which the inner material F is deposited is conveyed by the supply conveyor device 21 to a position at the center 5a of the opening 5.

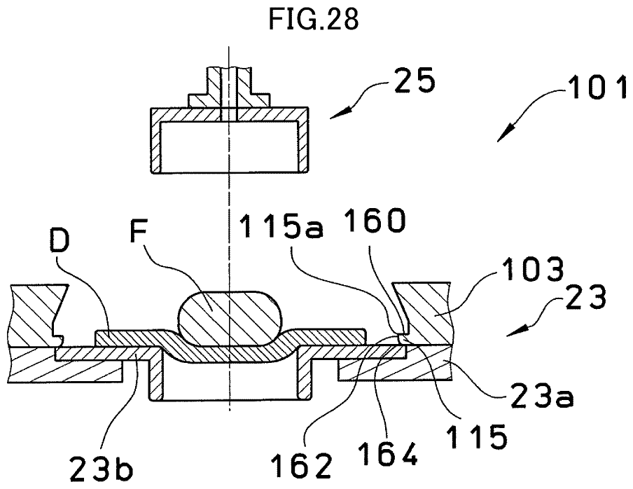

As shown in FIG. 28, the front-end portion 21a of the supply conveyor device 21 is retracted from the extended position to the standby position, so that the outer skin material D and the inner material F are placed onto the hole plate 23b.

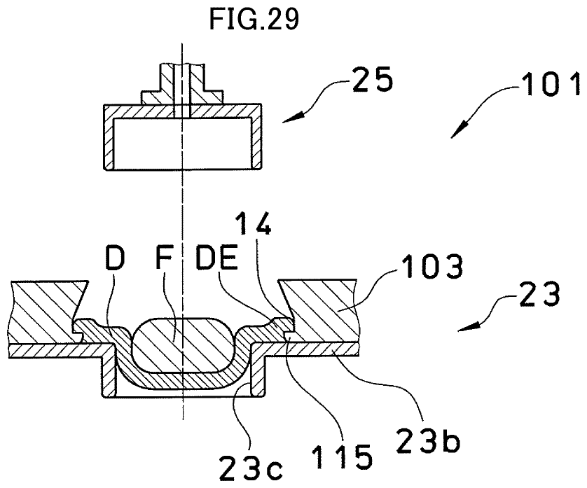

As shown in FIG. 29, the shutter device 23 is actuated to move the shutter set 102 toward the closed state. The vertical portion 162 of the lower portion 115 of the shutter piece 103 is allowed to contact the peripheral edge portion DE of the outer skin material D, and then, the horizontal portion 160 is allowed to get under the lower surface of the peripheral edge DE. Further, after the intermediate portion 14 is allowed to contact the peripheral edge of the outer skin material D, the closing action of the shutter set 102 is temporarily stopped.

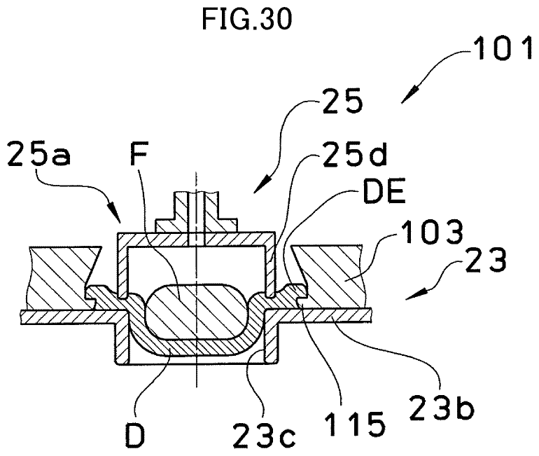

As shown in FIG. 30, the press member 25a of the press device 25 is lowered, and the peripheral edge portion DE of the outer skin material D is pressed against the hole plate 23b to seal the inner space formed between the outer skin material D and the press member 25a.

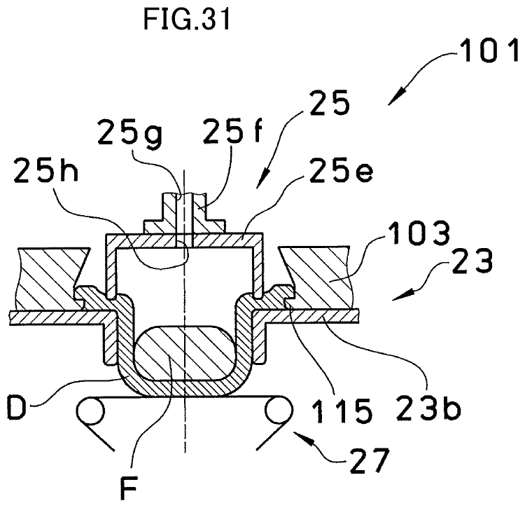

As shown in FIG. 31, by supplying compressed air into the inner space, the outer skin material D is expanded downward inside of the opening 23c to form a bowl-like shape. A bottom portion of the downward expanded outer skin material D is supported by the support device 27.

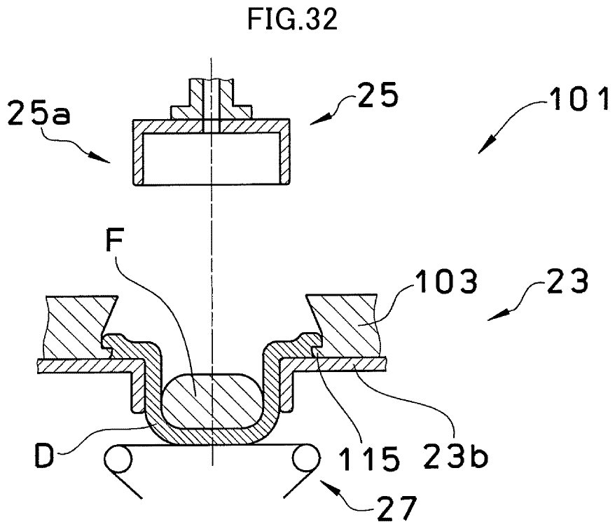

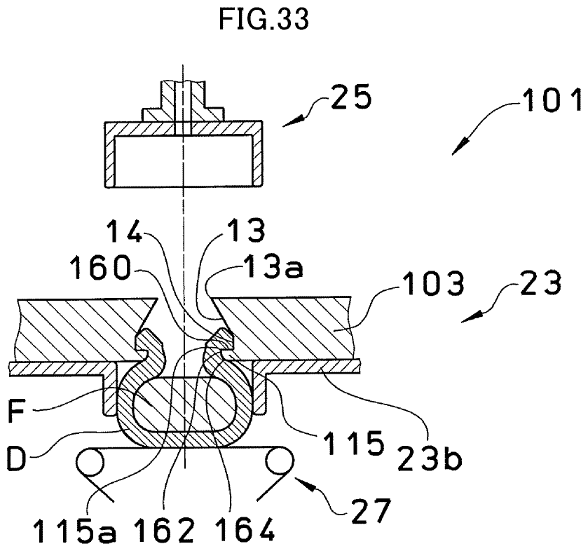

As shown in FIG. 32, the press member 25a is raised. As shown in FIG. 33, the shutter set 102 is moved toward the closed state again. The protruding lower portion 115 of the shutter piece 103 allows the outer skin material D near the inner material F to be held and, at the same time, concentrically gathered and stretched toward a position above the center of the inner material F. Since the horizontal portion 160 is configured to protrude more than the horizontal portion 60 in the first embodiment, an effect of holding the outer skin material D can be further enhanced. Further, since the lower slope portion 164 of the lower portion 115 is configured to be a convex curved surface having a larger curvature than a curvature of the lower slope portion 64 of the first embodiment, the effect of preventing the roughening of the surface can be further enhanced.

The closing action of the shutter set 102 is forwarded, and the inner material F is enveloped to be sealed by the outer skin material D surrounded by the eight lower portions 115 at a position above the inner material F. As shown in FIG. 34, the closing action of the shutter set 102 is further forwarded so that the opening 5 of the shutter set 102 is closed to form the ceiling space SS1.

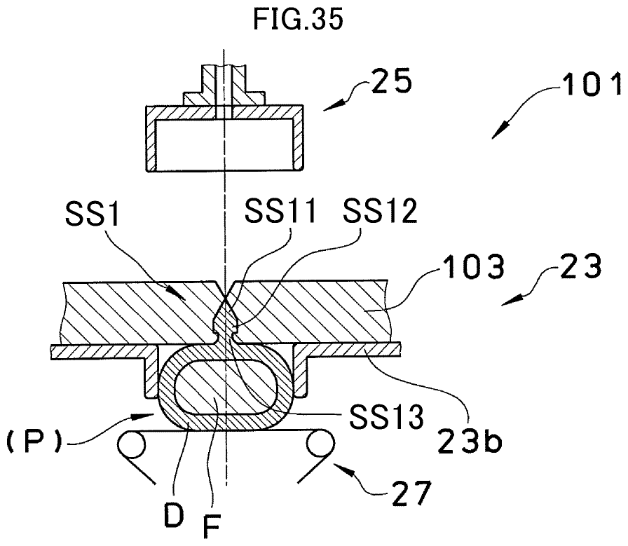

As shown in FIG. 35, as the closing action of the shutter set 102 is forwarded, a volume of the ceiling space SS1 is reduced. In the present embodiment, the lower portion 115 does not include an upper slope portion, and an upward surface is formed only by the horizontal portion 160. Thus, an effect of holding the outer skin material D by the lower portion 115 is larger than that in the first embodiment, while the outer skin material D remaining inside of the ceiling space SS1 is subject to a strong pressure from the shutter set 102 and pushed out. As a result, the peripheral edge portion DE of the outer skin material D is firmly attached and sealed to itself.

Further, as the ceiling space SS1 is gradually reduced, a protruding width of the lower portion 115 becomes smaller, so that the third space SS13 is not closed and the opening can be maintained.

As shown in FIG. 36, the shutter set 2 is moved to the fully-closed state, so that the closing action of the shutter set (unit) 2 is stopped, and the sealing operation of the outer skin material D due to the shutter set (unit) 2 is finished. At this time, the ceiling space SS1 exists only at the reduced third space SS13.

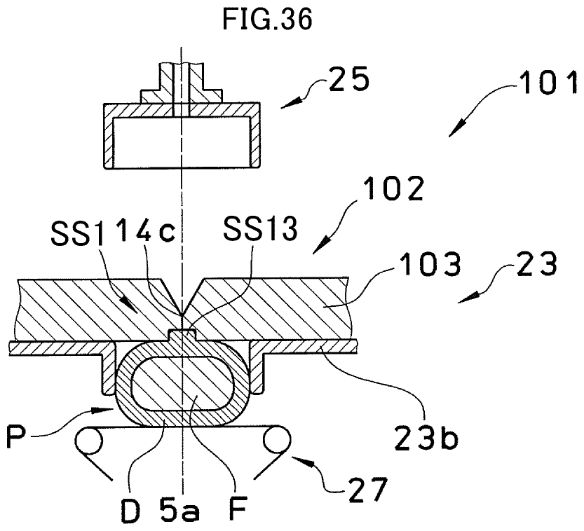

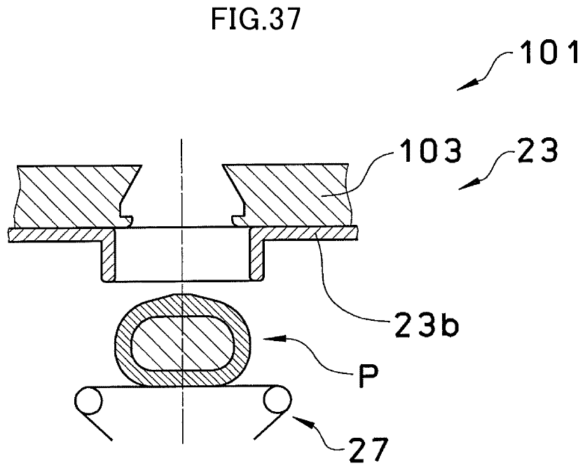

As shown in FIG. 37, the shutter set 102 is moved toward the opened state, the outer skin material D of the head of the enveloped food product P is released, and the support device 27 on which the enveloped food product P is deposited is lowered.

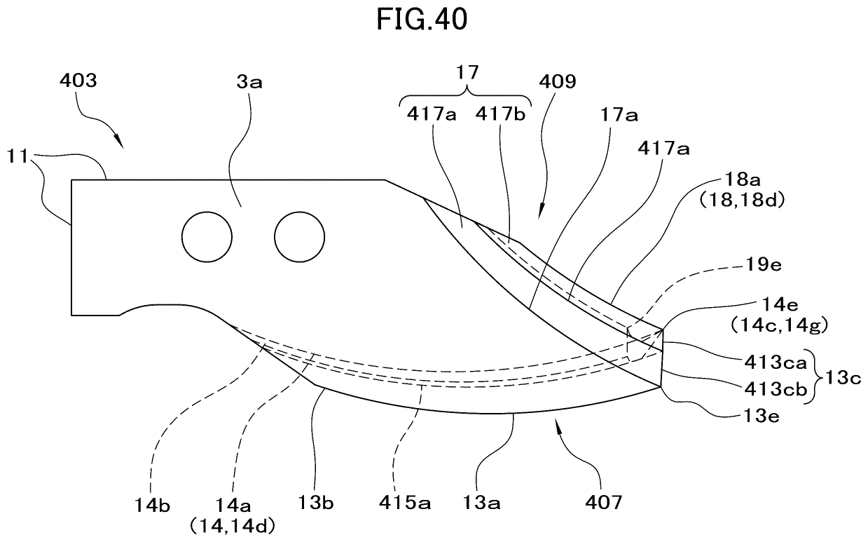

Next, referring to FIGS. 40-43, a shutter piece and a shutter set according to a third embodiment of the present invention will be explained.

A shutter piece 403 of the third embodiment according to the present invention has a structure which is similar to that of the shutter piece 3 of the first embodiment, but is different mainly from the upper portions 13, 17, the lower portions 15, 19 and the front-end surface 80 of the shutter piece 3. Components of the shutter piece 403 according to the third embodiment, which are similar to those of the shutter piece 3 according to the first embodiment, have the same reference numerals as those of the shutter piece 3, and their detailed explanation is omitted.

As shown in FIGS. 40-43, the shutter piece 403 has the upper surface 3a, the lower surface 3b, and side surfaces 407, 409, 11 located between the upper surface 3a and the lower surface 3b. The side surfaces 407, 409, 11 includes an opening-side surface 407 defining the opening 5, an abutting-side surface 409 defining the front-end edges 13c, 14c together with the opening-side surface 407, and the other side surfaces 11.

The opening-side surface 407 of the shutter piece 403 includes the upper portion 13, the intermediate portion 14, and a lower portion 415.

The upper portion 13 includes an upper slope portion 413a and a lower slope portion 413b. The upper slope portion 413a of the upper portion 13 is mainly defined by the upper edge 13a, a slope edge 413d, and a front-end edge 413ca, and extends obliquely downward from the upper edge 13a toward the slope edge 413d so as to be recessed from the upper edge 13a. The lower slope portion 413b is mainly defined by the slope edge 413d, the intermediate edge 14a, and a front-end edge 413cb, and extends obliquely downward from the slope edge 413d toward the intermediate edge 14a so as to be recessed from the slope edge 413d. The upper slope portion 413a has a downward slope which is preferably steeper than that of the lower slope portion 413b. The position of the front-end edge 13c (413ca, 413cb) of the upper portion 13 is preferably determined to pass through the center 5a of the opening 5 of a shutter set 402 when the shutter piece 403 is swung.

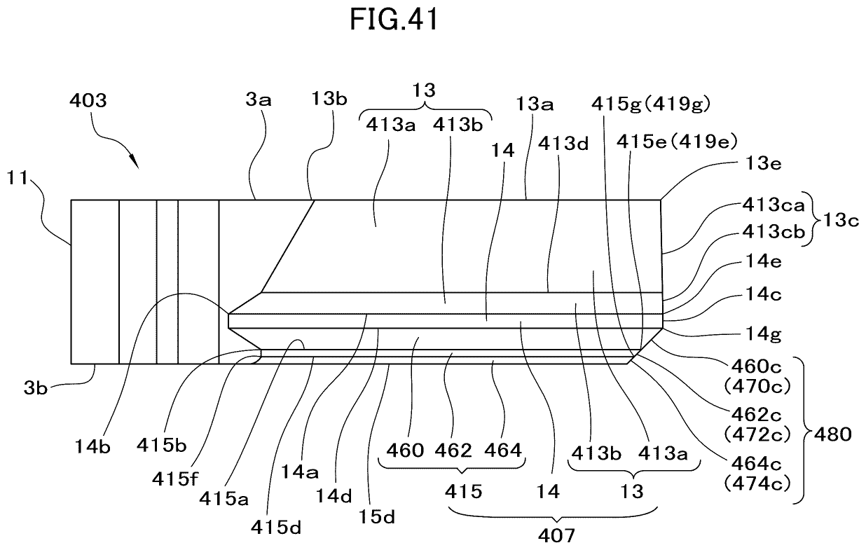

In the plan view, a front-side portion of the lower portion 415 is disposed to be recessed from the upper edge 13a, but to be protruded from the intermediate edge 14a and the lower intermediate edge 14d (the intermediate portion 14), and has a protruding edge 415a which is convex and arcuate. The protruding edge 415a extends from a base end 415b to a front end 415e (see FIG. 41). In the plan view, the protruding edge 415a is located between the upper edge 13a and the intermediate edge 14a (lower intermediate edge 14d). In the plan view, the front end 415e and the base end 415b are recessed toward the abutting-side surface 409 from the upper edge 13a and protruded toward the opening 5 (toward the opening-side surface 407) from the intermediate edge 14a (lower intermediate edge 14d).

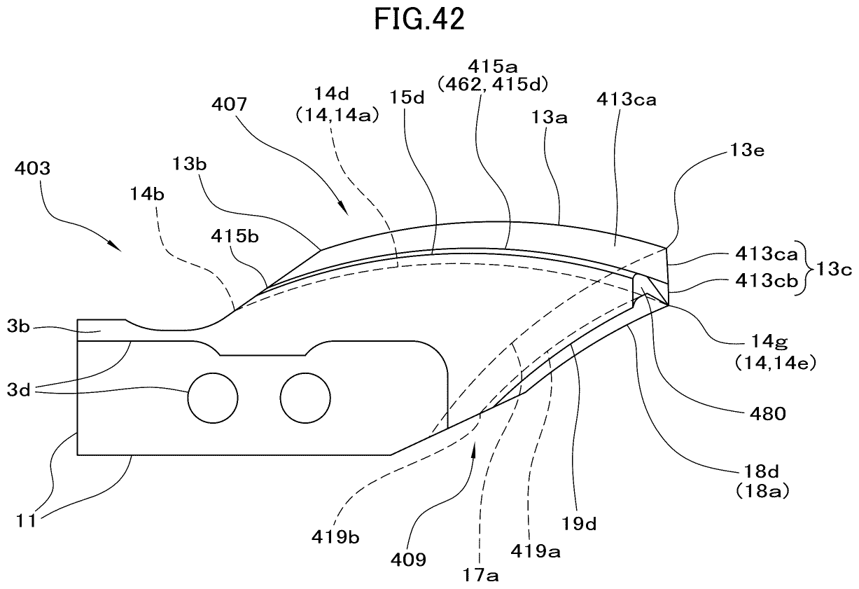

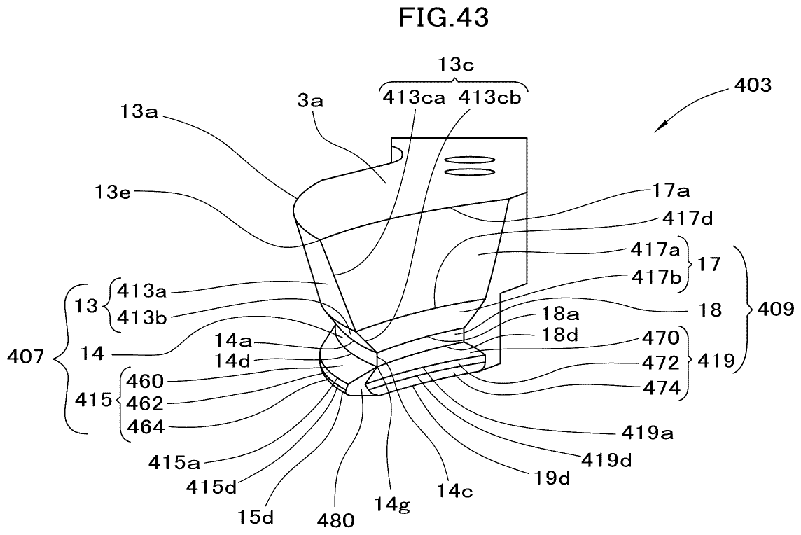

Specifically, the front-side portion of the lower portion 415 includes three surfaces, namely, an upper slope portion 460, a vertical portion 462, and a lower slope portion 464. The upper slope portion 460 is an upward surface disposed along the lower intermediate edge 14d (intermediate portion 14) and extends obliquely downward to protrude from the lower intermediate edge 14d (intermediate portion 14). In the plan view, a width of the upper slope portion 460 protruding from the intermediate portion 14 becomes larger from the base end 415b toward the front end 415e (see FIGS. 42 and 43). The vertical portion 462 extends downward from the upper slope portion 460. The lower slope portion 464 extends obliquely downward to the lower edge 15d (lower surface 3b) to be recessed from the vertical portion 462. The convex protruding edge 415a is a peripheral edge of the lower portion 415 and is defined by a boundary line between the upper slope portion 460 and the vertical portion 462. In the plan view, a width between the protruding edge 415a and the intermediate edge 14a becomes larger from the base end 415b toward the front end 415e (see FIGS. 40, 42 and 43).

The upper slope portion 460 extends obliquely downward to the protruding edge 415a to protrude from the lower intermediate edge 14d (intermediate portion 14). The vertical portion 462 is preferably a curved surface extending downward from the protruding edge 415a to the lower protruding edge 415d and vertically has the same contour. The lower protruding edge 415d extends from a base end 415f to a front end 415g. Further, the lower slope portion 464 is preferably an inclined surface extending obliquely downward from the lower protruding edge 415d of the vertical portion 462, and a profile of a vertical section of this inclined surface may be a straight line, a convex curved line, or a combination thereof. In this embodiment, the profile of the vertical section of the inclined surface of the lower slope portion 464 is a convex curved line. In the plan view, the lower edge 15d where the lower slope portion 464 intersects the lower surface 3b extends in a convex and arcuate way (see FIG. 42).

As shown in FIG. 41, the lower portion 415 further has a front edge 460c on a front side of the upper slope portion 460, a front edge 462c on a front side of the vertical portion 462, and a front edge 464c on a front side of the lower slope portion 464. The front end 415e of the protruding edge 415a is an intersection of the front edge 460c of the upper slope portion 460 and the front edge 462c of the vertical portion 462. The front end 415g of the lower protruding edge 415d is an intersection of the front edge 462c of the vertical portion 462 and the front edge 464c of the lower slope portion 464.

Further, in the plan view, the front edge 460c of the upper slope portion 460, the front edge 462c of the vertical portion 462, and the front edge 464c of the lower slope portion 464 are not located at the front-end edge 13c of the upper portion 13 and the front-end edge 14c of the intermediate portion 14, namely, they are offset toward the base end 415b of the protruding edge 415a so that they do not pass through the center 5a of the opening 5. In the present embodiment, as shown in FIG. 41, the upper slope portion 460, the vertical portion 462, and the lower slope portion 464 are formed with degrees relative to the front-end edge 14c of the intermediate portion 14 (a direction of the front end 14e of the intermediate edge 14a in the front view), for example, with forty-five degrees.

As shown in FIGS. 40-43, the abutting-side surface 409 of the shutter piece 403 has the upper portion 17, the intermediate portion 18, and a lower portion 419. Further, the upper portion 17 includes an upper slope portion 417a and a lower slope portion 417b, and the lower portion 419 includes an upper slope portion 470, a vertical portion 472, and a lower slope portion 474.

As shown in FIGS. 40-43, the upper slope portion 417a of the upper portion 17 is mainly defined by the upper edge 17a, a slope edge 417d and a front-end edge 413ca, and extends obliquely downward from the upper edge 17a toward the slope edge 417d to protrude from the upper edge 17a. The lower slope portion 417b is mainly defined by the slope edge 417d, the intermediate edge 18a, and a front-end edge 413cb, and extends obliquely downward from the slope edge 417d toward the intermediate edge 18a to protrude from the slope edge 417d. The upper slope portion 417a has a downward slope which is preferably steeper than that of the lower slope portion 417b.

The upper slope portion 470 of the lower portion 415 extends obliquely downward to be recessed from the lower intermediate edge 18d and has a front edge 470c on its front side. The vertical portion 472 extends downward from the upper slope portion 470 and has a front edge 472c on its front side. The lower slope portion 474 extends to the lower edge 19d (lower surface 3b) to protrude obliquely downward from the vertical portion 472 and has a front edge 474c on its front side. A recessed edge 419a between the upper slope portion 470 and the vertical portion 472 extends from a base end to the front end 419e, and the front end 419e is an intersection of the front edge 470c of the upper slope portion 470 and the front edge 472c of the vertical portion 472. A lower recessed edge 419d between the vertical portion 472 and the lower slope portion 474 extends from a base end to a front end 419g, and the front end 419g is an intersection of the front edge 472c of the vertical portion 472 and the front edge 474c of the lower slope portion 474.

Preferably, the front-end edge 13c (413ca, 413cb), the front-end edge 14c, and the front edges 470c, 472c, 474c are formed to always abut the upper portion 13, the intermediate portion 14, and the upper slope portion 460, the vertical portion 462, and the lower slope portion 464 of the lower portion 415 of the opening-side surface 407 of the adjacent shutter piece 403, respectively, without substantially causing any clearance when the shutter piece 403 is swung.

The upper portion 17, the intermediate portion 18, and the lower portion 419 of the abutting-side surface 109 are preferably formed in a concave shape to abut the upper portion 13, the intermediate portion 14, and the lower portion 415 in the opening-side surface 407 of the adjacent shutter piece, respectively, when the shutter set 404 is in the fully-closed state.

Specifically, the upper edge 13a, the slope edge 413d, and the intermediate edge 14a of the upper portion 13 of the opening-side surface 407 can abut the upper edge 17a, the slope edge 417d, and the intermediate edge 18a of the upper portion 17 of the abutting-side surface 409 of the adjacent shutter piece 403, respectively. The intermediate edge 14a and the lower intermediate edge 14d of the intermediate portion 14 of the opening-side surface 407 can abut the intermediate edge 18a and the lower intermediate edge 18d of the intermediate portion 18 of the abutting-side surface 409 of the adjacent shutter piece 403, respectively. The protruding edge 415a, the lower protruding edge 415d, and the lower edge 15d of the lower portion 415 of the opening-side surface 407 can abut the recessed edge 419a, the lower recessed edge 419d, and the lower edge 19d of the lower portion 419 of the abutting-side surface 409 of the adjacent shutter piece 403, respectively. Namely, in the plan view, each of the upper edge 17a, the slope edge 417d, the intermediate edge 18a, the lower intermediate edge 18d, the recessed edge 419a, the lower recessed edge 419d, and the lower edge 19d of the abutting-side surface 409 is formed to be concave and arcuate.

Further, in the plan view, the front edge 470c of the upper slope portion 470, the front edge 472c of the vertical portion 472, and the front edge 474c of the lower slope portion 474 are not located at the front-end edge 13c of the upper portion 17 and the front-end edge 14c of the intermediate portion 18, namely, they are offset toward the base end 419b of the recessed edge 419a so that they do not pass through the center 5a of the opening 5.

The shutter piece 403 has a front-end surface 480 below the front-end edge 14c which is offset closer to the base end 14b than the front-end edge 14c. The front-end surface 480 is formed to intersect the lower portions 415, 419 on the front-end side of the lower portions 415, 419.

Locating the front end 13e of the upper edge 13a of the opening side surface 407 of the shutter piece 403 at the center Sa of the opening 5 causes a state in which the opening 5 of the shutter set 402 is closed by the front end 13e (starting closing state). At this time, the front-end edges 13c (413ca, 413cb), 14c, and the front edges 470c, 472c, 474c abut the upper portion 13, the intermediate portion 14 and the lower portion 415 of the opening-side surface 407 of the adjacent shutter pieces 403, respectively. Thus, on the opening-side surface 407 of each shutter piece 403, a ceiling space SS4 with concaveness and convexness is formed and surrounded by the inclined upper portion 13, the vertically-extending intermediate portion 14, the lower portion 415 protruding toward the opening 5, and the front-end surface 480 offset from the front end toward the base end of the shutter piece 403. The ceiling space SS4 is defined in a top-down order by a first space SS41 with substantially octagonal pyramid and frustum surrounded by the eight upper portions 13, a second space SS42 with a substantially octagonal prism surrounded by the eight intermediate portions 14, and the remaining third space SS43.

While the shutter set 402 is moved from the starting closing state to the fully-closed state, the ceiling space SS4 is entirely reduced. Specifically, a height and a diameter of the first space SS41 are reduced, and a diameter of the second space SS42 is reduced.

As a result, when the shutter set 402 reaches the fully-closed state, the first space SS41 and the second space SS42 have not existed so that the ceiling space SS4 is defined only by the third space SS43.

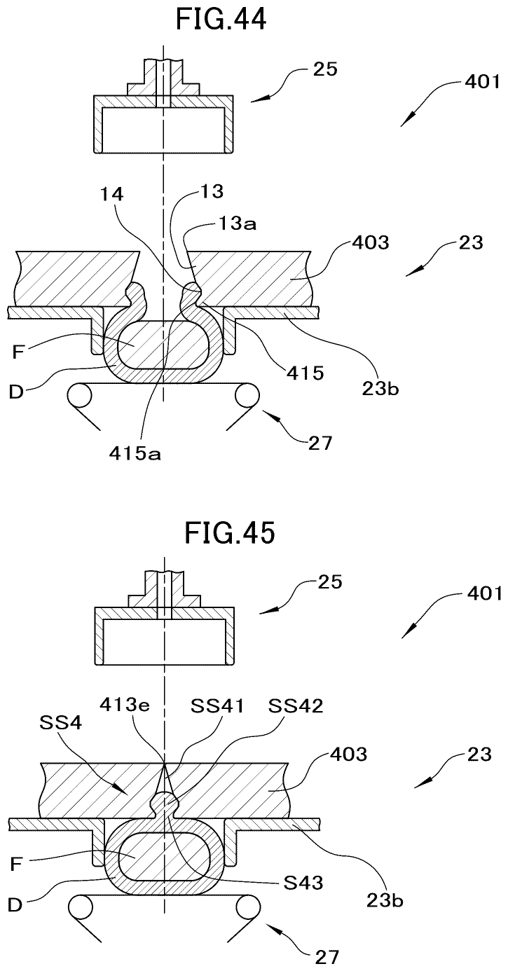

Next, referring to FIGS. 44-48, an operation of the forming apparatus 401 will be explained. Detailed explanation of portions of the operation of the forming apparatus 104 according to the third embodiment which are similar to portions of the operation of the forming apparatus 1 according to the first embodiment is omitted. Specifically, since FIGS. 12-17 according to the first embodiment is substantially common to the third embodiment, explanation of FIGS. 12-17 is omitted.

As shown in FIG. 44, the shutter set 402 is moved toward the fully-closed state. The protruding lower portion 415 of the shutter piece 403 allows the outer skin material D near the inner material F to be held and, at the same time, concentrically gathered and stretched toward a position above the center of the inner material F. In the plan view, since a width of the upper slope portion 460 protruding from the intermediate portion 14 becomes larger from the base end 415b toward the front end 415e, as the shutter set 402 is moved closer to the fully-closed state, a force for holding the outer skin material D can be become larger. Further, the outer skin material D can be held until a timing immediately before the shutter set 402 is moved to the fully-closed state. As a result, an amount of gathering the outer skin material D can be stabilized, and the production can be stabilized. Further, since the lower slope portion 464 of the lower portion 415 is formed of a convex curved surface, the effect of preventing the roughening on the surface can be further enhanced.

The closing action of the shutter set 402 is forwarded, and the inner material F is enveloped to be sealed by the outer skin material D surrounded by the eight lower portions 15 at a position above the inner material F. As shown in FIG. 45, the closing action of the shutter set 102 is further forwarded so that the opening 5 of the shutter set 102 is closed to form the ceiling space SS4.

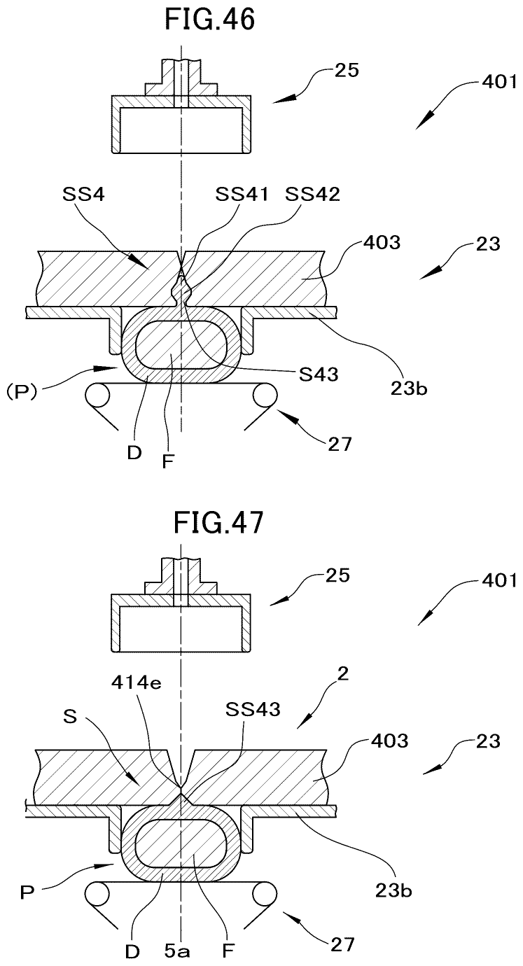

As shown in FIG. 46, as the closing action of the shutter set 102 is forwarded, a volume of the ceiling space SS4 is reduced. As a result, the peripheral edge portion DE of the outer skin material D is firmly sealed.

Further, since the front sides of the upper slope portion 460, the vertical portion 462, and the lower slope portion 464 are formed by forty-five degrees relative to the front-end edge 14c of the intermediate portion 14, as the ceiling space SS4 is gradually reduced, the opening can be maintained without closing the third space SS43.

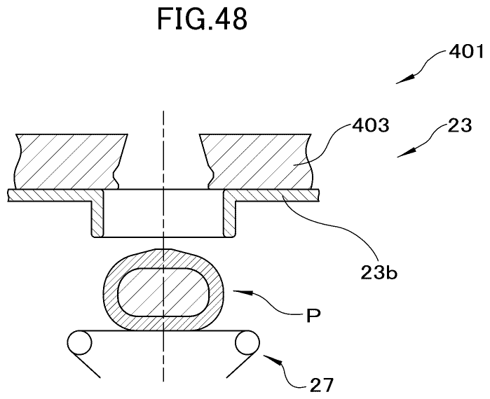

As shown in FIG. 47, the shutter set 402 is moved to the fully-closed state, so that the closing action of the shutter set (unit) 402 is stopped, and the sealing operation of the outer skin material D due to the shutter set (unit) 402 is finished. At this time, the ceiling space SS4 exists only at the reduced third space SS43.

As shown in FIG. 48, the shutter set 402 is moved toward the opened state, the outer skin material D of the head of the enveloped food product P is released, and the support device 27 on which the enveloped food product P is deposited is lowered.

Explanation of the shutter piece and the shutter set according to the embodiments of the present invention has been generally done, but the present invention is not limited to the above-explained shutter piece and the shutter set so that various modifications can be done within the scope of the claims.

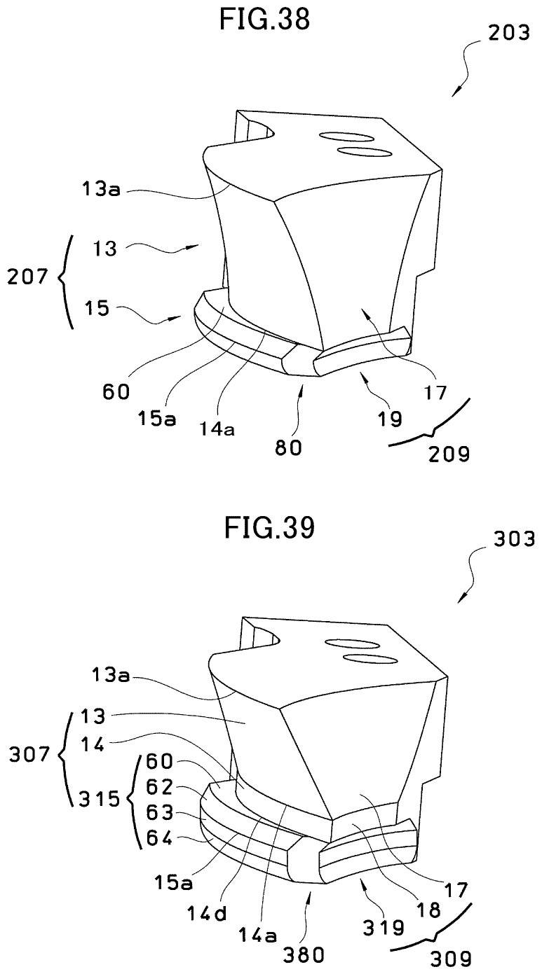

For example, while in the above-stated embodiments, the shutter piece 3, 103, 403 has been explained to include the intermediate portion 14, 18, the intermediate portion may be omitted, as a shutter piece 203 of a first alternative of the first embodiment shown in FIG. 38.

The shutter piece 203 includes an opening-side surface 207 and an abutting-side surface 209. The opening-side surface 207 includes the upper portion 13 and the lower portion 15 below the upper portion 13. A profile of a vertical section of the upper portion 13 is recessed. In the plan view, the protruding edge 15a of the lower portion 15 is located between the upper edge 13a and the intermediate and lower edges 14a, 13d. Further, the abutting-side surface 209 includes the upper and lower portions 17, 19 corresponding to the opening-side surface 207.

Even in this alternative, a ceiling space can be formed in the shutter unit, so that the outer skin material D to be attached and sealed to itself is not leaked onto an upper surface of the shutter unit to form an enveloped food product P. Further, since the profile of the vertical section of the upper portion 13 is formed to be recessed, an amount of storing the outer skin material in the ceiling space can increase and a third space can be formed for assuming a role of a squeezing valve in the ceiling space, so that the peripheral edge portion DE of the outer skin material D can be surely attached and sealed to itself.

Further, as a shutter piece 303 of a second alternative of the first embodiment shown in FIG. 39, a vertical portion may be added between the upper slope portion and the lower slope portion of the lower portion.

A lower portion 315 of an opening-side surface 307 of a shutter piece 303 includes a horizontal portion 60, an upper slope portion 62, a vertical portion 63, and a lower slope portion 64. The vertical portion 63 extends downward from the protruding edge 15a, namely, a lower end of the upper slope portion 62 and is a curved surface vertically having the same contour. Further, the lower slope portion 64 extends obliquely downward from the vertical portion 63 to be recessed from the vertical portion 63.

An abutting-side surface 309 of the shutter piece 303 includes a lower portion 319 corresponding to the lower portion 315 of the opening side surface 307. Further, a front-end surface 380 intersects the lower portions 315, 319 on a front side of the lower portions 315, 319. In this way, by causing the height of the lower portion to be larger to lengthen a passage of the third space S3, the outer skin material D can be subject to a high pressure to be pushed out from the ceiling space S, so that the peripheral portion DE of the outer skin material D can be surely attached and sealed to itself.

Further, a vertical portion which has the same contour as that of the upper surface 3a of the shutter piece 3 may be added to extend from the upper portion 13, 15. Even in this case, the ceiling space S can be formed.
1, 101, 401: forming apparatus
2, 102, 402: shutter set
3, 103, 403: shutter piece
3c: front edge
3f: intermediate lower surface (horizontal lower surface)
4c: front edge
5: opening
5a: center
7, 107, 207, 307, 407: opening-side surface
9, 109, 209, 309, 409: abutting-side surface
13: upper portion (first side surface)
13a: upper edge (peripheral edge)
13b: base end
13e: front end
13d: lower edge
14: intermediate portion (intermediate side surface)
14a: intermediate edge (lower edge of the upper portion)
15, 115, 315, 415: lower portion (second side surface)
15a, 115a, 415a: protruding edge (peripheral edge)
15b, 115b, 415b: base end
15e, 115e, 415e: front end
23: shutter device
60, 160: horizontal portion
62: upper slope portion
63: vertical portion
64, 164: lower slope portion
80, 180, 380: front surface
162: vertical portion
D: outer skin material (food dough)
DE: peripheral portion
F: inner material
P: enveloped food product
S, SS1, SS4: ceiling space
S1, SS11, SS41: first space
S2, SS14, SS42: second space
S3, SS13, SS43: third space

1-6. (canceled)

7. A shutter piece of a shutter device used for enclosing an inner material supplied on a center of a disk-like outer skin material by the outer skin material and sealing a peripheral portion of the outer skin material above the inner material,
the shutter device having an opening defined by a plurality of shutter pieces, the opening being capable of opening and closing by swinging the plurality of shutter pieces,
the shutter piece having an opening-side surface which faces the opening and includes an upper portion and a lower portion disposed below the upper portion,
the upper portion having an upper edge and an intermediate edge disposed below the upper edge, and is configured to close a front end of the intermediate edge after a front end of the upper edge is closed when the plurality of shutter pieces is swung to close the opening, the intermediate edge being disposed to be recessed from the upper edge,
the lower portion including a protruding edge disposed between the upper edge and the intermediate edge in the plan view,
the shutter piece being configured to define a ceiling space for receiving the peripheral portion of the outer skin material when the front end of the upper edge is closed, the ceiling space including an upper space defined by the upper portion, a lower space defined by the lower portion and reduced more in diameter than the upper space, and
the shutter piece being configured to reduce the upper space while the outer skin material in the ceiling space is held by the lower portion until the front end of the intermediate edge is closed.

8. The shutter piece defined in claim 7,
wherein a width of the protruding edge of the lower portion and the intermediate edge of the upper portion in the plan view becomes larger toward the front end of the intermediate edge.

9. The shutter piece defined in claim 7,
wherein a width of the protruding edge of the lower portion and the intermediate edge of the upper portion in the plan view becomes smaller toward the front end of the intermediate edge.

10. The shutter piece defined in claim 7,
wherein the lower portion has a horizontal portion which is an upward surface for holding the outer skin material.

11. The shutter piece defined in claim 7,
wherein the opening-side surface includes an intermediate portion between the upper portion and the lower portion, the intermediate portion having the same profile vertically.

12. A shutter set which is a combination of the shutter pieces defined in claim 7.
